(19) United States
(12) Patent Application Publication
(10) Pub. No.: US 2026/0034796 A1
(43) Pub. Date: Feb. 5, 2026

(54) LIQUID COLLECTING DEVICE AND LIQUID COLLECTION CONTAINER

(71) Applicant: SEIKO EPSON CORPORATION, Tokyo (JP)

(72) Inventors: Shoma KUDO, Shiojiri-shi (JP); Yoshiharu MIZUNO, Matsumoto-shi (JP)

(73) Assignee: SEIKO EPSON CORPORATION, Tokyo (JP)

(21) Appl. No.: 19/285,614

(22) Filed: Jul. 30, 2025

(30) Foreign Application Priority Data
Jul. 31, 2024 (JP) 2024-124794

(51) Int. Cl. B41J 2/175; B41J 2/21

(52) U.S. Cl. CPC B41J 2/17596; B41J 2/2103

(57) ABSTRACT

A liquid collecting device collects a liquid remaining in a liquid accommodation container. The liquid accommodation container includes a plurality of port portions including a pouring port portion and a supply port portion. The supply port portion is a port portion through which the liquid can be supplied to a liquid discharger that discharges the liquid. The liquid collecting device includes a liquid collection container and a pressure generator. The liquid collection container includes a collection port portion configured such that the collection port portion can be coupled to a port portion of the liquid accommodation container. The pressure generator is provided separately from the liquid collection container and generates a pressure that causes the liquid in the liquid accommodation container to move into the liquid collection container through the port portion and the collection port portion coupled to each other.

The present application is based on, and claims priority from JP Application Serial Number 2024-124794, filed Jul. 31, 2024, the disclosure of which is hereby incorporated by reference herein in its entirety.

### BACKGROUND

### 1. Technical Field

The present disclosure relates to a liquid collecting device and a liquid collection container for collection of a liquid remaining in a liquid accommodation container that can accommodate a liquid to be supplied to a liquid discharger.

### 2. Related Art

For example, disclosed as an example of a liquid discharging apparatus in JP-A-2018-69717 is an ink jet printing apparatus including a liquid discharger that discharges a liquid, such as an ink, onto a medium, such as a paper sheet.

Such a type of liquid discharging apparatus includes a liquid accommodation container that accommodates liquid to be supplied to a liquid discharger. As an example of the liquid accommodation container, a liquid replenishment type liquid tank (for example, an ink tank or the like) having a pouring port portion through which a user can replenish the liquid tank with a liquid is known in addition to a replaceable cartridge (for example, an ink cartridge or the like). When the amount of a liquid in a liquid replenishment type liquid accommodation container (a liquid tank) is reduced, a user replenishes the liquid accommodation container with a liquid by coupling a supply bottle, such as an ink bottle, to a pouring port portion.

Meanwhile, when a liquid discharging apparatus is to be discarded, a cartridge is collected for recycling in many cases. Even when the entire liquid discharging apparatus including the cartridge is discarded, a liquid is less likely to leak from the cartridge since the cartridge does not include a pouring port portion.

However, the liquid replenishment type liquid accommodation container is fixed to a housing or a carriage of a liquid discharging apparatus. Therefore, in many cases, the liquid discharging apparatus is discarded with the liquid accommodation container fixed thereto. However, when a liquid, such as an ink, remains in the liquid accommodation container, there is a possibility that the liquid in the liquid accommodation container leaks through the pouring port portion, of which a cap has been loosened or removed, when the liquid discharging apparatus is tilted or the like during a discarding operation. The liquid leaking from the liquid accommodation container may not be processed, which results in environmental pollution. Therefore, when a liquid discharging apparatus including a tank type liquid accommodation container is to be discarded, it is preferable that a user discards the liquid discharging apparatus after collecting a liquid in a liquid accommodation container. In addition, even when a liquid replenishment type liquid accommodation container is removed from a liquid discharging apparatus, the same problem occurs when a liquid remains in a case where the removed liquid accommodation container is discarded.

However, in the case of a liquid replenishment type liquid accommodation container in the related art, a configuration in which a liquid remaining in the liquid accommodation container is collected when a liquid discharging apparatus is to be discarded has not been considered. Therefore, it is desired to appropriately collect the liquid remaining in the liquid accommodation container when the liquid discharging apparatus is to be discarded. In addition, in some cases, it is preferable that the liquid remaining in the liquid accommodation container can be collected not only when the liquid discharging apparatus is to be discarded but also when the liquid discharging apparatus is to be transported or maintenance of the liquid discharging apparatus is to be performed.

### SUMMARY

According to an aspect of the present disclosure, there is provided a liquid collecting device collecting a liquid remaining in a liquid accommodation container including a plurality of port portions including a pouring port portion through which the liquid is poured and a supply port portion through which the liquid is supplied to a liquid discharger that discharges the liquid, the liquid collecting device including a liquid collection container that includes a collection port portion configured to be coupled to a port portion of the liquid accommodation container and a pressure generator that is provided separately from the liquid collection container and that generates a pressure that causes the liquid in the liquid accommodation container to move into the liquid collection container through the port portion and the collection port portion coupled to each other.

### BRIEF DESCRIPTION OF THE DRAWINGS

FIG. 1 is a perspective view showing a liquid discharging apparatus according to a first embodiment.

FIG. 2 is a perspective view showing the liquid discharging apparatus at the time of replenishment of a liquid accommodation container with a liquid.

FIG. 3 is a schematic side sectional view showing an internal configuration of the liquid discharging apparatus.

FIG. 4 is a schematic plan view showing a liquid supply unit including a plurality of liquid accommodation containers.

FIG. 5 is a sectional view taken along line V-V in FIG. 4.

FIG. 6 is a schematic view showing a liquid collecting device.

FIG. 7 is a schematic perspective view showing one set of components of the liquid collecting device.

FIG. 8 is a schematic side sectional view showing a configuration of a negative pressure type liquid collecting device.

FIG. 9 is a perspective view showing a pipe member.

FIG. 10 is a schematic bottom view showing a state where the pipe member is inserted into a pouring port portion.

FIG. 11 is a schematic side sectional view showing a state where the liquid collecting device is assembled.

FIG. 12 is a schematic side sectional view showing a state where the negative pressure type liquid collecting device collects a liquid in the liquid accommodation container.

FIG. 13 is a schematic side sectional view showing a state where a liquid is supplied from a liquid collection container to the liquid accommodation container.

FIG. 14 is a schematic side sectional view showing a configuration of a pressurization type liquid collecting device according to a second embodiment.

FIG. 15 is a perspective view showing a pipe member.

FIG. 16 is a schematic bottom view showing a state where the pipe member is inserted into a pouring port portion.

FIG. 17 is a schematic side sectional view showing a state where the pressurization type liquid collecting device collects a liquid in a liquid accommodation container.

### DESCRIPTION OF EMBODIMENTS

### First Embodiment

Hereinafter, a liquid collecting device according to a first embodiment will be described with reference to drawings. The liquid collecting device collects a liquid remaining in a liquid accommodation container that the liquid discharging apparatus includes.

### Configuration of Liquid Discharging Apparatus 11

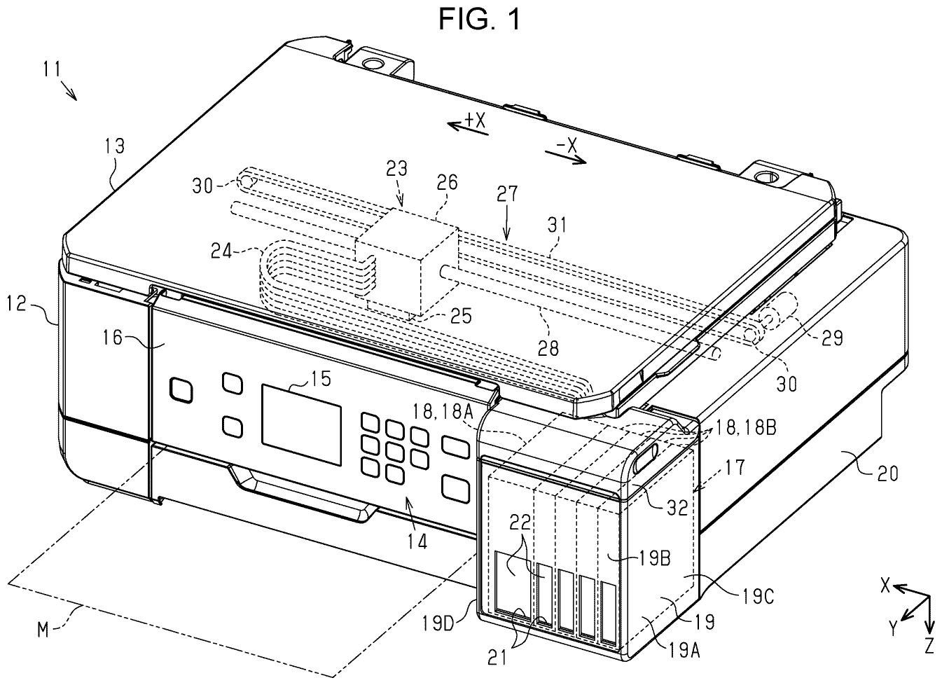

First, a liquid discharging apparatus 11 will be described with reference to FIGS. 1 to 3.

As shown in FIG. 1, the liquid discharging apparatus 11 is, for example, an ink jet printer that discharges an ink, which is an example of a liquid.

In FIG. 1, it will be assumed that the liquid discharging apparatus 11 is placed on a horizontal plane, and three directions orthogonal to each other will be referred to as an X direction, a Y direction, and a Z direction, respectively. The Z direction parallel to the gravity direction will be referred to as a perpendicular direction Z. In addition, the X direction and the Y direction along the horizontal plane, which are orthogonal to each other, will be referred to as a width direction X and a transportation direction Y, respectively. The X direction is a width direction of the liquid discharging apparatus 11. The Y direction is a direction parallel to a depth direction of the liquid discharging apparatus 11. In the case of the liquid discharging apparatus 11 of the present embodiment, a transportation direction in which a medium M is transported from a printing position, at which printing is performed on the medium M, is parallel to the Y direction. In addition, one end side in the transportation direction Y of the liquid discharging apparatus 11 may be referred to as a front side, and another end side opposite to the one end side may be referred to as a rear side. One end side in the width direction X as seen from the front side may be referred to as a right side, and another end side in the width direction X may be referred to as a left side. Note that a direction in which the medium M is transported on a transportation path changes depending on a position on the transportation path. In the present embodiment, the Z direction may be referred to as a gravity direction Z when description about the gravity is to be made.

The liquid discharging apparatus 11 may be a multi-function machine. The liquid discharging apparatus 11, which is also a multi-function machine, may include an apparatus main body 12 and an image reading device 13 provided at an upper portion of the apparatus main body 12. The liquid discharging apparatus 11 has an approximately rectangular parallelepiped-like shape as a whole.

The liquid discharging apparatus 11 includes liquid accommodation containers 18 that accommodate liquids and a liquid discharger 23 that discharges the liquids. The liquid accommodation containers 18 are configured such that the liquids can be supplied to the liquid discharger 23. The liquid discharging apparatus 11 prints a character or an image on the medium M with the liquid discharger 23 discharging the liquids, such inks, supplied from the liquid accommodation containers 18 toward the medium M. The liquid discharging apparatus 11 of the present embodiment is, for example, a serial printer that performs printing while the liquid discharger 23 is moving in the width direction X. The liquid discharging apparatus 11 may also be a line printer. The line printer performs printing on the medium M with the liquid discharger 23 discharging the liquids, such as inks, toward the medium M transported at a constant speed, the liquid discharger 23 extending in the width direction X by a length larger than a width dimension of the medium M.

The liquid discharging apparatus 11 of the present embodiment is a so-called off-carriage type liquid discharging apparatus in which the liquid accommodation containers 18 are fixed in the apparatus main body 12 at positions separated from the liquid discharger 23. The liquid accommodation containers 18 and the liquid discharger 23 are coupled through supply flow paths 24. The liquid discharger 23 discharges liquids that are supplied from the liquid accommodation containers 18 through the supply flow paths 24. The supply flow paths 24 are, for example, tubes. As shown in FIG. 1, the liquid discharging apparatus 11 includes a housing 20. The housing 20 accommodates the liquid accommodation containers 18 and the liquid discharger 23. The housing 20 is composed of, for example, a housing main body and a lid. The housing main body has a bottomed box-like shape with an opening that is open upward. The lid covers the opening of the housing main body. In the liquid discharging apparatus 11 which is a multi-function machine, a bottom portion of the image reading device 13 also serves as the lid. The housing 20 includes, for example, a metal frame structure and a synthetic resin exterior member. The exterior member covers the frame structure from the outside.

A front surface of the liquid discharging apparatus 11 is provided with an operation panel 14. The operation panel 14 includes an operation portion 15 and a displayer 16. The operation portion 15 includes buttons and the like used to perform various operations. The displayer 16 displays a menu and various kinds of information, such as the state of operation of the liquid discharging apparatus 11.

A front end portion of the liquid discharging apparatus 11 is provided with an accommodation portion 19. The accommodation portion 19 may be disposed, for example, to the right of the operation panel 14. At least one liquid accommodation container 18 is accommodated in the accommodation portion 19. In the present embodiment, a plurality of (in the present embodiment, five) liquid accommodation containers 18 are accommodated in the accommodation portion 19. The accommodation portion 19 constitutes a portion of the housing 20. In other words, the housing 20 includes the accommodation portion 19 that accommodates the plurality of liquid accommodation containers 18. The liquid accommodation containers 18 are liquid replenishment type liquid accommodation containers configured such that the liquid accommodation containers 18 can be replenished with liquids, such as inks. That is, the liquid accommodation containers 18 are liquid replenishment type liquid tanks. The liquid tanks are, for example, ink tanks that can accommodate inks, which are examples of liquids.

The accommodation portion 19 includes an approximately box-shaped accommodation portion main body 19A with an opening that is open upward, and a cover 32. The accommodation portion main body 19A includes a front portion 19B and two right and left side portions 19C and 19D. The cover 32 covers the opening of the accommodation portion main body 19A such that the opening can be opened and closed. The accommodation portion main body 19A includes at least one visual recognition window 21 (in the present embodiment, five visual recognition windows 21) provided at the front portion. That is, the housing 20 includes the visual recognition windows 21 provided at the front portion of the accommodation portion 19. A user can visually recognize the amounts of liquids in the liquid accommodation containers 18 through the visual recognition windows 21.

As shown in FIG. 1, the plurality of liquid accommodation containers 18 are arranged in a row along the width direction X, in the accommodation portion 19. In an example shown in FIG. 1, the plurality of liquid accommodation containers 18 are five liquid accommodation containers 18 in total including one liquid accommodation container 18A and four liquid accommodation containers 18B. The capacity of the liquid accommodation container 18A is larger than the capacities of the liquid accommodation containers 18B. The liquid accommodation container 18A accommodates, for example, a black ink. The four liquid accommodation containers 18B respectively accommodate, for example, inks having different colors. The plurality of liquid accommodation containers 18 may accommodate, for example, a cyan ink, a magenta ink, a yellow ink, a black ink, and the like. The ink may be a pigment ink or a dye ink. A black pigment ink and a black dye ink may be accommodated in the liquid accommodation containers 18A and 18B, respectively. In addition, liquids used for printing are not limited to inks and may be a coating liquid or the like.

The two types of liquid accommodation containers 18A and 18B have the same basic configuration except that the width dimensions thereof are different from each other since the capacities thereof are different from each other. Therefore, the two types of liquid accommodation containers 18A and 18B will be simply referred to as “the liquid accommodation containers 18” when the two types of liquid accommodation containers 18A and 18B are not to be particularly distinguished from each other.

The liquid discharger 23 includes a discharge head 25 and a carriage 26. The carriage 26 can reciprocate in the width direction X (a scanning direction) while holding the discharge head 25. The liquid discharger 23 performs printing on the medium M by discharging liquids from the discharge head 25 while moving in the width direction X.

The liquid discharging apparatus 11 includes a scanning mechanism 27 that is provided in the housing 20 and that causes the liquid discharger 23 to move (perform a scan). The scanning mechanism 27 includes a guide shaft 28 that guides the carriage 26 to be movable in the width direction X, a carriage motor 29 that is a driving source, a pair of pulleys 30, and an endless timing belt 31 wound around the pair of pulleys 30. One of the paired pulleys 30 is fixed to an output shaft of the carriage motor 29. When the carriage motor 29 is driven to rotate forward, the liquid discharger 23 moves in a +X direction and when the carriage motor 29 is driven to rotate backward, the liquid discharger 23 returns in a −X direction.

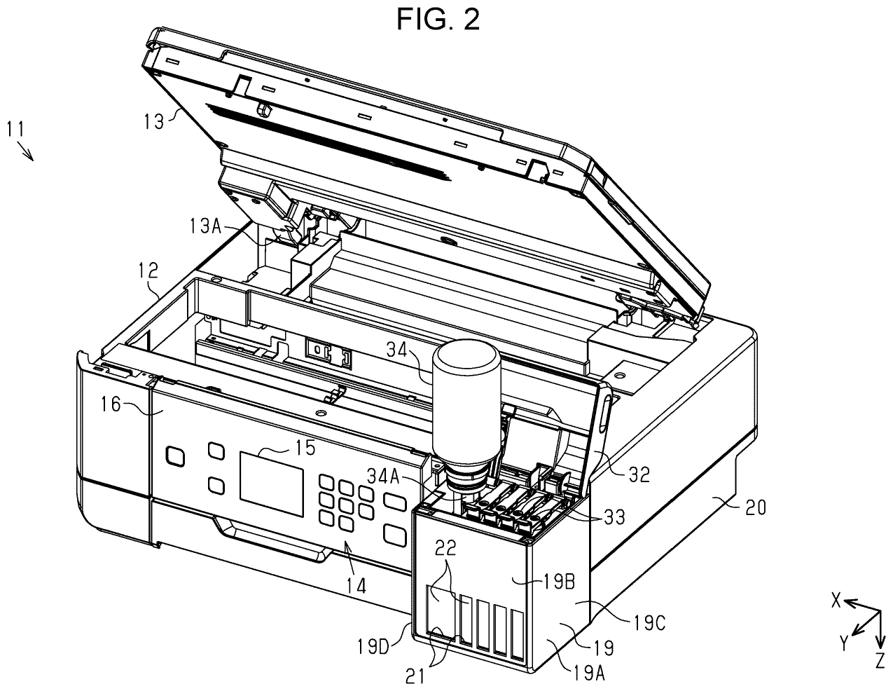

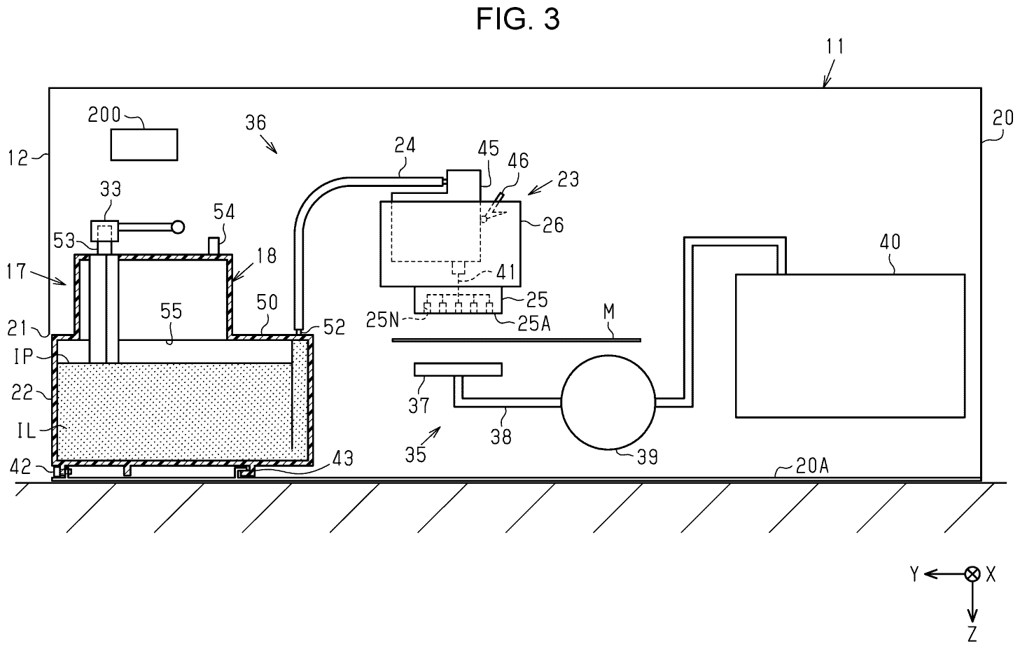

As shown in FIG. 2, the image reading device 13 is configured to be openable and closable with respect to the apparatus main body 12 via a rotation mechanism 13A such as a hinge. The image reading device 13 has a function as a lid. The image reading device 13 can be opened and closed between a closing position shown in FIG. 1 and an opening position shown in FIG. 2. When the image reading device 13 is positioned at the opening position, the cover 32 can be opened and closed. When the cover 32 is opened, cap levers 33 attached to the liquid accommodation containers 18 (refer to FIG. 1) can be opened and closed. When liquids, such as inks, are to be supplied to the liquid accommodation containers 18, as shown in FIG. 2, the image reading device 13, the cover 32, and the cap levers 33 are positioned at opening positions, respectively. A discharge port portion 34A of a supply bottle 34, which is an example of a liquid supply container, is coupled to a pouring port portion 53 (refer to FIG. 3) of the liquid accommodation container 18 in an inverted posture in which the discharge port portion 34A faces a lower side. Note that the cover 32 may be configured to be capable of being opened and closed alone even when the image reading device 13 is in a closed state. Internal Configuration of Liquid Discharging Apparatus 11

Next, the internal configuration of the liquid discharging apparatus 11 will be described with reference to FIG. 3. As shown in FIG. 3, the discharge head 25 includes a nozzle formation surface 25A at which nozzles 25N are open. In an example shown in FIG. 3, a plurality of nozzles 25N are open at the nozzle formation surface 25A. The discharge head 25 is configured such that liquids can be discharged from the plurality of nozzles 25N. For example, the plurality of nozzles 25N may be provided for each of the types (for example, the colors) of liquids to be discharged.

The liquid discharging apparatus 11 includes a maintenance device 35 that performs maintenance of the discharge head 25 and liquid supply devices 36 that supply liquids from the liquid accommodation containers 18 to the discharge head 25. The maintenance device 35 includes a cap 37 that can be raised and lowered and a discharge tube 38 coupled to the cap 37. The cap 37 is configured to be movable between a withdrawal position that is separated from the discharge head 25 and that is shown in FIG. 3 and a capping position (not shown) at which the cap 37 comes into contact with the nozzle formation surface 25A of the discharge head 25 when the discharge head 25 is at a standby position. The cap 37 can receive liquids discharged from the nozzles 25N for maintenance.

At the capping position, the cap 37 forms a closed space between the nozzle formation surface 25A and the cap 37, the closed space communicating with the nozzles 25N. The maintenance device 35 includes a suction pump 39 provided at an intermediate portion of the discharge tube 38. The maintenance device 35 drives the suction pump 39 in a state where the discharge head 25 is capped such that the pressure in the closed space surrounded and formed by the cap 37 and the nozzle formation surface 25A is reduced. Due to the reduction in pressure, foreign substances such as air bubbles are sucked and discharged from the nozzles 25N of the discharge head 25 together with liquids. The liquid discharged from the nozzles 25N through cleaning is collected into a waste liquid accommodation portion 40 through the cap 37 and the discharge tube 38.

Although only one liquid supply device 36 is shown in FIG. 3, a plurality of the liquid supply devices 36 are provided corresponding to the plurality of liquid accommodation containers 18. The plurality of liquid supply devices 36 have basically the same configuration as each other.

As shown in FIG. 3, the liquid supply device 36 includes the liquid accommodation container 18 and the supply flow path 24. Through the supply flow path 24, a liquid in the liquid accommodation container 18 is supplied to the discharge head 25. The supply flow path 24 is, for example, a tube that can be bent and deformed. The supply flow path 24 may include a pipe material made of a hard resin material.

The carriage 26 is provided with a sub tank 45. The sub tank 45 temporarily stores, on the carriage 26, a liquid that is supplied from the liquid accommodation container 18, which is a main tank, through the supply flow path 24. The sub tank 45 is locked with respect to the carriage 26 via a locking portion 46.

A direction in which a liquid is supplied from the liquid accommodation container 18 to the discharge head 25 in the supply flow path 24 will be referred to as a supply direction. An upstream end portion (one end portion) of the supply flow path 24 in the supply direction is coupled to the liquid accommodation container 18. A downstream end portion (another end portion) of the supply flow path 24 is coupled to the sub tank 45. The sub tank 45 is coupled to an upstream end portion of a flow path 41 that the carriage 26 includes. A downstream end portion of the flow path 41 is coupled to the discharge head 25. A liquid in the liquid accommodation container 18 is supplied to the discharge head 25 through the supply flow path 24, the sub tank 45, and the flow path 41.

The liquid accommodation container 18 is fixed to a bottom portion 20A of the housing 20 via a fastening portion 42. The liquid accommodation container 18 is positioned at a predetermined position with respect to the bottom portion 20A of the housing 20 via a position restriction portion 43. The liquid accommodation container 18 is fixed, via the fastening portion 42, to the predetermined position in the accommodation portion 19 at which the position of the liquid accommodation container 18 is restricted with respect to the bottom portion 20A. The fastening portion 42 may be a fastening realized by a screw. The fastening portion 42 may individually fix the plurality of liquid accommodation containers 18 to the housing 20, or may fix a liquid supply unit 17, which is obtained by combining the plurality of liquid accommodation containers 18 into one unit, to the housing 20. The fixation structure of the liquid accommodation container 18 with respect to the housing 20 may be, for example, a snap-fit structure or the like.

The liquid accommodation container 18 includes a liquid accommodation portion 50. The liquid accommodation portion 50 is configured to be capable of accommodating a liquid. The liquid accommodation portion 50 includes a liquid accommodation chamber 55 that accommodates a liquid IL, such as an ink. The liquid accommodation portion 50 is composed of a case made of a synthetic resin. The case may be made of a transparent or translucent synthetic resin. In addition, the liquid accommodation portion 50 may have a configuration in which the liquid accommodation chamber 55 is surrounded and formed with a film fixed to one surface of an accommodation chamber forming member, the accommodation chamber forming member having a recess portion for an accommodation chamber formed at the one surface.

As shown in FIG. 3, the liquid accommodation container 18 includes a plurality of port portions including a supply port portion 52, the pouring port portion 53, and an atmosphere communication port portion 54. The supply port portion 52, the pouring port portion 53, and the atmosphere communication port portion 54 may be provided to protrude at an outer peripheral surface of the liquid accommodation portion 50.

The supply port portion 52 is a portion through which a liquid is supplied to the liquid discharger 23. One upstream end portion of the supply flow path 24 is coupled to the supply port portion 52.

The pouring port portion 53 is a portion through which a liquid is poured into the liquid accommodation portion 50. The pouring port portion 53 is configured such that a liquid can be poured. The discharge port portion 34A of the supply bottle 34 shown in FIG. 2 can be coupled to the pouring port portion 53.

The atmosphere communication port portion 54 is a portion through which a space above a liquid surface IP in the liquid accommodation portion 50 communicates with the atmosphere. Even when the amount of the liquid IL in the liquid accommodation portion 50 increases or decreases, the pressure in the space above the liquid surface IP is maintained at the atmospheric pressure.

A visual recognition surface 22 provided at a front surface of the liquid accommodation container 18 is exposed through the visual recognition window 21. A user can visually recognize the amount of a liquid remaining in the liquid accommodation chamber 55 through the visual recognition surface 22.

As shown in FIG. 3, the discharge head 25 is positioned above the liquid surface IP in the liquid accommodation container 18 in the perpendicular direction Z. Specifically, openings of the nozzles 25N are positioned above the liquid surface IP when the liquid surface IP is at the maximum height in the liquid accommodation container 18. Therefore, a negative pressure acts on liquids in the nozzles 25N as a back pressure. Accordingly, the liquids do not trickle from the nozzles 25N, and meniscuses of the liquids in the nozzle 25N are formed. The liquid IL in the liquid accommodation container 18 is supplied, by means of a hydraulic head difference between the liquid surface IP and the meniscuses in the nozzles 25N, to the discharge head 25 to compensate for consumption of liquids at the nozzles 25N. Note that a configuration in which a pump that sends the liquid IL in the liquid accommodation chamber 55 to the discharge head 25 is provided may also be adopted.

As shown in FIG. 3, the liquid discharging apparatus 11 includes a controller 200 that controls the operation of the entire apparatus. The controller 200 controls the carriage motor 29 (refer to FIG. 1) that causes the carriage 26 to reciprocate, a transporter (not shown) that transports the medium M, a discharging operation of the discharge head 25, a cleaning operation of the maintenance device 35, and the like.

### Configuration of Liquid Accommodation Containers 18

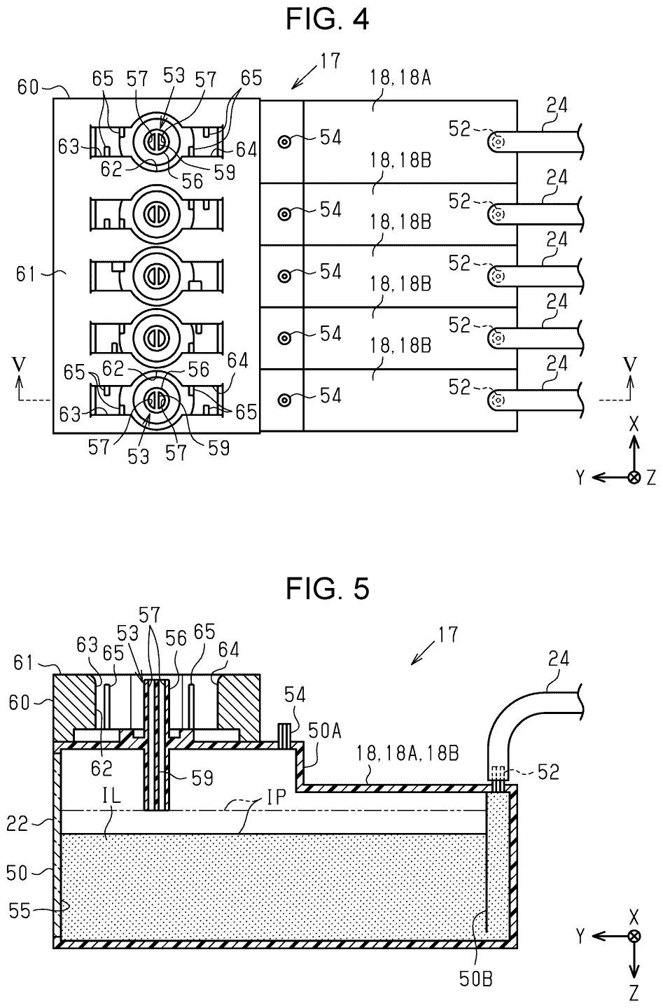

Next, the configuration of the liquid supply unit 17 will be described with reference to FIGS. 4 and 5. Note that the two types of liquid accommodation containers 18A and 18B have the same basic configuration although the width dimensions thereof are different from each other since the capacities thereof are different from each other. Note that in FIG. 4, the X direction is a thickness direction of the liquid accommodation containers 18.

As shown in FIG. 4, the liquid supply unit 17 includes the plurality of (for example, five) liquid accommodation containers 18. The plurality of liquid accommodation containers 18 are provided to be capable of accommodating liquids having different colors. For example, the plurality of liquid accommodation containers 18 may include the liquid accommodation container 18A that accommodates a black liquid and of which the thickness is large and the liquid accommodation containers 18B that respectively accommodate liquids of four colors including a color and of which the thicknesses are small. All of the plurality of liquid accommodation containers 18 may have the same thickness, or a mixture of two or more types of liquid accommodation containers 18 having different thicknesses may be provided.

The liquid accommodation container 18 includes the liquid accommodation portion 50. The liquid accommodation portion 50 includes a protrusion portion 50A provided at an upper portion thereof. The protrusion portion 50A is a portion protruding toward a position above the liquid accommodation portion 50 in a side view shown in FIG. 5. The liquid accommodation container 18 includes the supply port portion 52, the pouring port portion 53, and the atmosphere communication port portion 54 as examples of the port portions. The port portions 52 to 54 may be portions protruding in a tubular shape from the outer peripheral surface of the liquid accommodation portion 50.

The liquid accommodation portion 50 includes the liquid accommodation chamber 55 provided in the liquid accommodation portion 50. The liquid accommodation chamber 55 is a chamber in which a liquid is accommodated. The supply port portion 52, the pouring port portion 53, and the atmosphere communication port portion 54 communicate with the liquid accommodation chamber 55. The pouring port portion 53 may be provided at an upper surface of the protrusion portion 50A. The pouring port portion 53 may be a pipe portion protruding upward from the upper surface of the protrusion portion 50A. The atmosphere communication port portion 54 may be provided at the upper surface of the protrusion portion 50A. The atmosphere communication port portion 54 may be a pipe portion protruding upward from the upper surface of the protrusion portion 50A.

As shown in FIG. 4, for accommodation of different types of liquids, the liquid supply unit 17 includes N (for example, five) liquid accommodation containers 18 respectively corresponding to the different types of liquids. Therefore, N (for example, five) liquid collection containers 70, of which the number is the same as the number of the N (for example, five) liquid accommodation containers 18, are provided. In the present embodiment, N is a natural number equal to or greater than 2. That is, a liquid collecting device 68 includes a plurality of the liquid collection containers 70.

The liquid supply unit 17 includes a coupling member 60 that collectively assembles the plurality of liquid accommodation containers 18. The coupling member 60 has a rectangular parallelepiped-like shape as seen in a plan view shown in FIG. 4. The coupling member 60 integrates all the liquid accommodation containers 18 with each other in a state where the liquid accommodation containers 18 are arranged side by side in the thickness direction. The coupling member 60 may be assembled on upper surfaces of the protruding portions 50A of all the liquid accommodation containers 18. The coupling member 60 covers upper surfaces of the plurality of liquid accommodation containers 18 in a state where a plurality of the pouring port portions 53 are exposed. The coupling member 60 may be a separate member that covers the upper surfaces of the liquid accommodation containers 18, or may be integrally formed with the liquid accommodation containers 18. The coupling member 60 may extend rearward to cover upper surfaces of the liquid accommodation portions 50 except the upper surfaces of the protruding portions 50A. Note that the coupling member 60 may rotatably support the cap levers 33 (refer to FIG. 3).

As shown in FIGS. 4 and 5, the liquid accommodation container 18 includes a gas-liquid exchange portion 56. At the gas-liquid exchange portion 56, gas-liquid exchange in which a liquid in the supply bottle 34 and air are exchanged is performed when the liquid is poured through the pouring port portion 53 from the supply bottle 34. The gas-liquid exchange portion 56 includes two flow paths 57. The gas-liquid exchange portion 56 has a tubular shape extending in the perpendicular direction Z. The pouring port portion 53 constitutes an upper end portion of the gas-liquid exchange portion 56. Specifically, an upper portion of the tubular gas-liquid exchange portion 56 protrudes from an upper surface of the liquid accommodation portion 50, so that the pouring port portion 53 is formed. Regarding the two flow paths 57, a liquid flows through one of the two flow paths 57 and a gas (air) flows through the other of the two flow paths 57.

As shown in FIG. 4, in a top view (a plan view) of the liquid supply unit 17, the two flow paths 57 constituting the gas-liquid exchange portion 56 are separated by a partition wall portion 59. The partition wall portion 59 partitions the inside of the gas-liquid exchange portion 56 into the two flow paths 57 extending in the perpendicular direction Z. In an example shown in FIG. 4, the two flow paths 57 have semicircular shapes facing each other with the plate-shaped partition wall portion 59 interposed therebetween. As shown in FIGS. 4 and 5, the two flow paths 57 extend in the perpendicular direction Z in a state of being adjacent to each other with the partition wall portion 59 interposed therebetween. The two flow paths 57 have the same length as each other, for example. Although the two flow paths 57 have the same flow path shape, for example. However, the two flow paths 57 may have different flow path shapes. Both of the two flow paths 57 extend in the perpendicular direction Z. The flow paths 57 are formed such that the heights of openings at both ends are approximately equal to each other and cross-sectional areas thereof are approximately equal to each other. Note that the two flow paths 57 may have different sizes or different hole shapes.

Openings at lower ends of the two flow paths 57 determine the maximum height position of the liquid surface IP which is represented by a two-dot chain line in FIG. 5. Through the two flow paths 57, the liquid IL from the supply bottle 34 can be supplied to the inside of the liquid accommodation chamber 55 until the liquid surface IP reaches the maximum height position represented by the two-dot chain line in FIG. 5.

As shown in FIG. 5, the supply port portion 52, the pouring port portion 53, and the atmosphere communication port portion 54 are provided at the upper surface of the liquid accommodation portion 50. The supply port portion 52, the pouring port portion 53, and the atmosphere communication port portion 54 communicate with the liquid accommodation chamber 55. The supply port portion 52, the pouring port portion 53, and the atmosphere communication port portion 54 are positioned above, for example, the maximum height position of the liquid surface IP. The supply port portion 52, the pouring port portion 53, and the atmosphere communication port portion 54 communicate with an air area above the liquid surface IP at the maximum height position in the liquid accommodation chamber 55.

Through the atmosphere communication port portion 54, the air area in the liquid accommodation chamber 55 communicates with the atmosphere. A communication path through which the atmosphere communication port portion 54 and the liquid accommodation chamber 55 communicate with each other may include a fine hole of a meandering path. Moisture of the liquid IL stored in the liquid accommodation chamber 55 is less likely to evaporate through the atmosphere communication port portion 54 since such a type of fine hole is interposed between the atmosphere communication port portion 54 and the liquid accommodation chamber 55.

The liquid accommodation container 18 includes a flow path forming wall 50B that extends downward in the liquid accommodation chamber 55 from an upper portion of the liquid accommodation portion 50. The inside of the liquid accommodation chamber 55 is partitioned by the flow path forming wall 50B into a region in which a liquid is accommodated and a flow path region in which the liquid is guided to the supply port portion 52. The height of the liquid surface IP in the region in which the liquid is accommodated changes as the liquid IL is consumed or supplied. Even at the time of a change in height of the liquid surface IP, the flow path region is full of the liquid IL. Such a phenomenon results from a hydraulic head difference between the liquid accommodation container 18 and the discharge head 25.

As shown in FIGS. 4 and 5, the coupling member 60 includes a horizontal upper surface 61. The coupling member 60 includes through-holes 62 that penetrate the upper surface 61 in a thickness direction (the perpendicular direction Z). The through-hole 62 is composed of a circular hole portion in which the pouring port portion 53 (the gas-liquid exchange portion 56) is disposed at the center thereof and a pair of front and rear rectangular hole portions that are aligned with the pouring port portion 53 while being positioned ahead of and behind the pouring port portion 53. The pair of front and rear hole portions of the through-hole 62 form a pair of front and rear recess portions around the pouring port portion 53. A first identification portion 63 is formed by the pair of front and rear recess portions.

In addition, as shown in FIGS. 4 and 5, the first identification portion 63 includes a first uneven portion 64 having an uneven shape characteristic in a plane direction. That is, the plurality of liquid accommodation containers 18 shown in FIG. 4 include the first uneven portions 64 formed in different uneven shapes respectively corresponding to the types (the colors) of liquids to be accommodated, the first uneven portions 64 being provided near the pouring port portions 53. The type of a liquid is, for example, the color type of the liquid.

As shown in FIG. 4, the first uneven portion 64 is provided for each of the pouring port portions 53 of the plurality of (for example, five) liquid accommodation containers 18. A plurality of the first uneven portions 64 include projection portions 65 that determine the respective uneven shapes of the first uneven portions 64. The plurality of first uneven portions 64 are formed in uneven shapes that are different from each other in number of projection portions 65, positions of the projection portions 65, and sizes of the projection portions 65. An identification portion (not shown) that can be engaged with the first uneven portion 64 and that has an uneven shape is provided near the discharge port portion 34A of the supply bottle 34. The identification portion of the supply bottle 34 and the first identification portion 63 can be engaged with each other (fitted to each other) when liquid types (for example, colors) match each other. That is, the uneven shapes are key shapes with which it is possible to identify whether or not both the identification portions (uneven portions) match each other and both the identification portions can be engaged with each other when the color of a liquid in the supply bottle 34 and the color of a liquid in the liquid accommodation container 18 are the same as each other. The discharge port portion 34A of the supply bottle 34 becomes able to be coupled to the pouring port portion 53 when both the identification portions are engaged with each other. The first identification portion 63 is configured to be engageable with a second identification portion 75 on the liquid collection container 70 side when a collection port portion 72 of the liquid collection container 70, which will be described later, is coupled to the pouring port portion 53.

In addition, for each through-hole 62, a portion of the upper surface 61 of the coupling member 60 that is near the through-hole 62 may be colored with a specific color. That is, each of portions near the through-holes 62 may be colored with the same color as the color of a liquid to be poured through the pouring port portion 53. Liquids of specific colors are poured into the liquid accommodation chambers 55 via respective pouring port portions 53.

### Configuration of Liquid Collecting Device 68

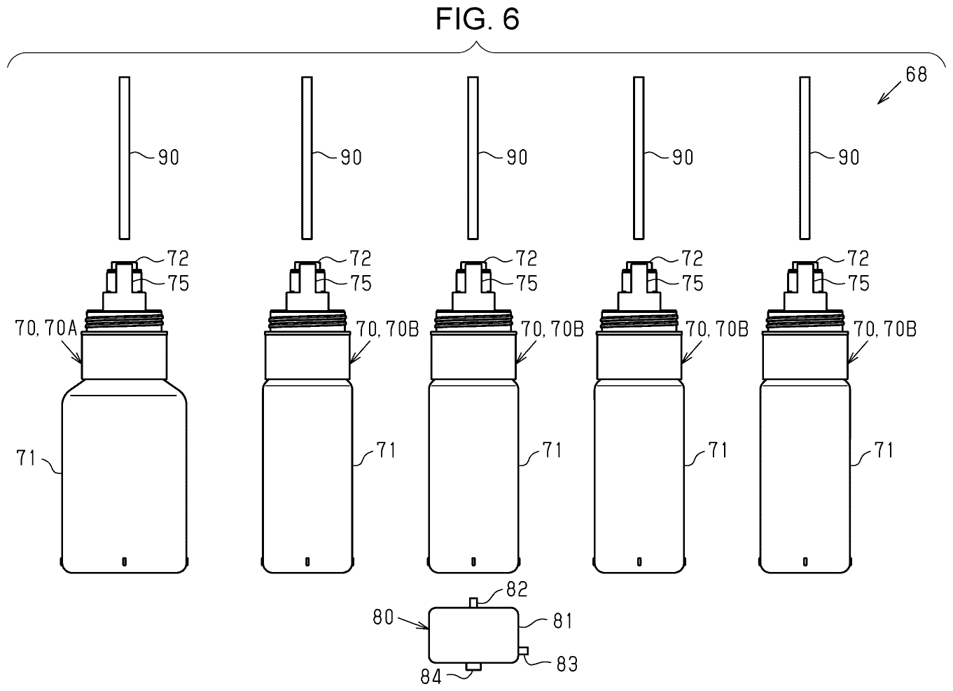

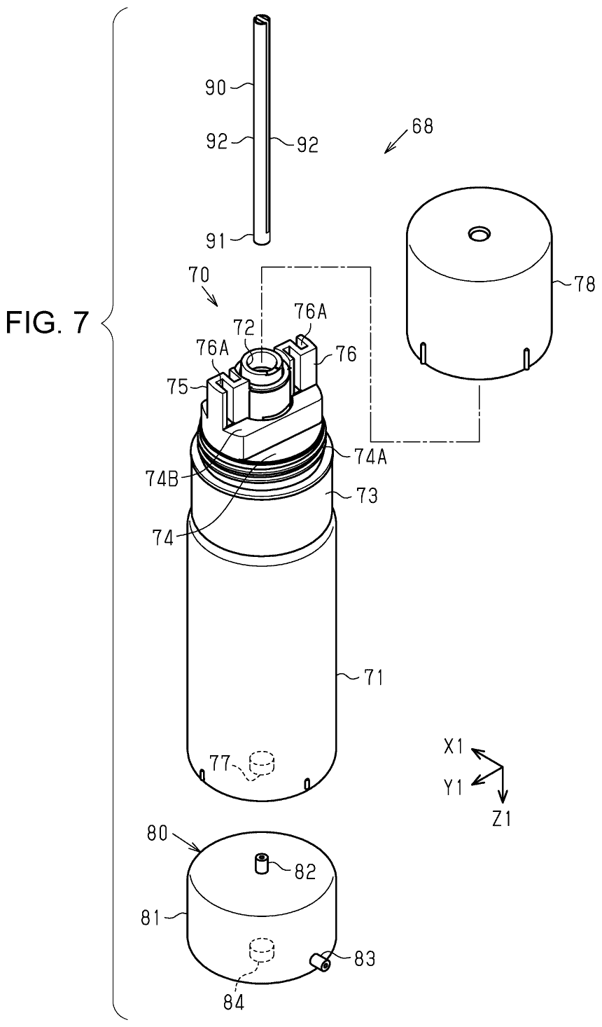

Next, the configuration of the liquid collecting device 68 will be described with reference to FIGS. 6, 7, and the like.

FIG. 6 shows the liquid collecting device 68. FIG. 7 shows one set of components of the liquid collecting device 68.

The liquid collecting device 68 collects a liquid remaining in the liquid accommodation container 18. The liquid collecting device 68 is used when the liquid remaining in the liquid accommodation container 18 is to be collected. For example, the liquid collecting device 68 is used when the liquid discharging apparatus 11 is to be discarded, when the liquid discharging apparatus 11 is to be transported, or when maintenance of the liquid discharging apparatus 11 is to be performed.

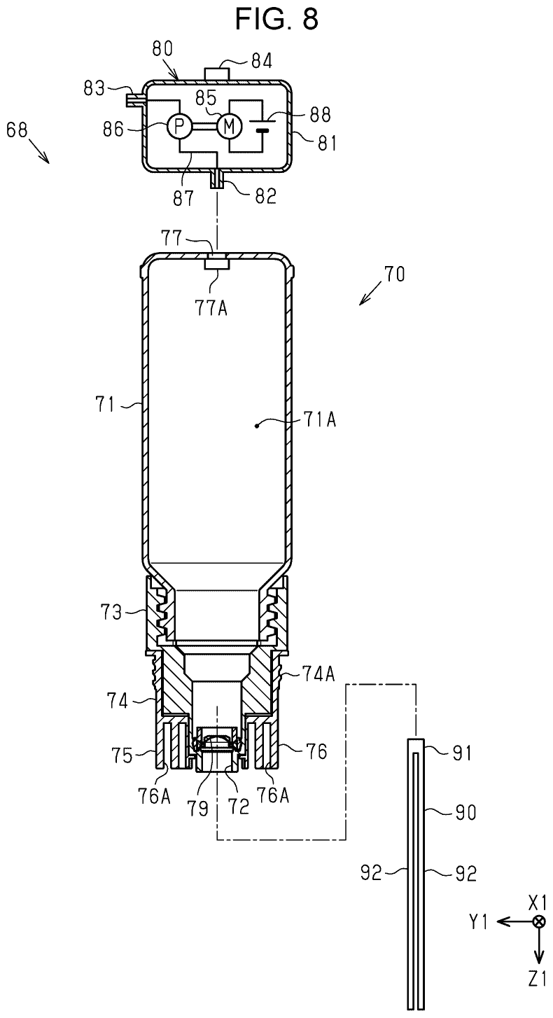

A user obtains the liquid collecting device 68 when a liquid in the liquid accommodation container 18 is to be collected. For example, the liquid collecting device 68 may be provided together with the liquid discharging apparatus 11 at the time of purchase of the liquid discharging apparatus 11. In addition, the user may obtain the liquid collecting device 68 from the manufacturer or a store at a price or without charge when the user discards the liquid discharging apparatus 11. Furthermore, the supply bottles 34 may also serve as the liquid collection containers 70 of the liquid collecting device 68. That is, a configuration in which the supply bottle 34 is used as the liquid collection container 70 when a liquid in the supply bottle 34 is used up may also be adopted. In addition, a configuration in which a component forming a coupling target portion 77 (refer to FIG. 8) to be coupled to a pressure generator 80, which will be described later, is inserted into a bottom portion of the supply bottle 34 so that the supply bottle 34 is used as the liquid collection container 70 may also be adopted. A configuration in which such a component includes a tubular needle portion and the needle portion is inserted into the bottom portion of the supply bottle 34 may also be adopted. A configuration in which a valve portion 77A is disposed inside the bottom portion of the supply bottle 34 and the needle portion is inserted into the valve portion 77A may also be adopted.

As shown in FIG. 6, the liquid collecting device 68 includes the liquid collection containers 70 and the pressure generator 80. Furthermore, the liquid collecting device 68 may include pipe members 90.

The plurality of liquid collection containers 70 are provided to respectively correspond to the types of liquids to be collected from the liquid accommodation containers 18 (refer to FIGS. 4 and 5). The type of a liquid may be the color type of the liquid. When a liquid is an ink, the type of the liquid may be the color type of the ink.

For accommodation of different types of liquids, the N (for example, five) liquid accommodation containers 18 are provided to respectively correspond to the different types of liquids. Therefore, the N (for example, five) liquid collection containers 70, of which the number is the same as the number of the N (for example, five) liquid accommodation containers 18, are provided. In the present embodiment, N is a natural number equal to or greater than 2. That is, the liquid collecting device 68 includes the plurality of liquid collection containers 70.

In an example shown in FIG. 6, the capacities of the N liquid collection containers 70 are different from each other in accordance with the liquid capacities of the liquid accommodation containers 18 from which liquids are collected. In the present embodiment, two types of liquid collection containers 70 having different capacities may be provided since the two types of liquid accommodation containers 18A and 18B (refer to FIGS. 1 and 4) having different capacities are provided. In FIG. 6, the N liquid collection containers 70 are composed of one large-capacity liquid collection container 70A positioned on the leftmost side and (N−1) normal-capacity liquid collection containers 70B. Note that the capacities of the N liquid collection containers 70 may be equal to each other, may be three or more different types of capacities, or may be different from each other.

Regarding the capacities of the liquid collection containers 70, the liquid collection container 70 has a capacity enough to completely collect an amount of a liquid corresponding to the maximum capacity of the liquid accommodation container 18 from which a liquid is to be collected, the liquid being accommodated in the liquid accommodation container 18. The liquid collection container 70 has a capacity enough to completely collect the liquid IL remaining in the liquid accommodation container 18 from which liquid is to be collected even when an amount of the liquid IL corresponding to the maximum capacity of the liquid accommodation container 18 remains in the liquid accommodation container 18.

The liquid collection container 70 is a bottle type container as with the supply bottle 34. Since the liquid collection container 70 is a bottle type container, a collected liquid can be reused by being supplied to the liquid accommodation container 18. That is, the liquid collection container 70 has a function as a supply bottle in which a collected liquid is reused in addition to a function as a liquid collection bottle. The liquid collection container 70 has the same function as the supply bottle 34.

The liquid collection container 70 includes a container main body 71 and the collection port portion 72. The liquid collection container 70 is a bottle type container. The container main body 71 corresponds to a bottle main body and has a bottomed cylindrical shape. The collection port portion 72 is provided at a tip end portion (an upper end portion) of the liquid collection container 70 that is on a side opposite to a bottom portion of the container main body 71.

The collection port portion 72 is configured such that the collection port portion 72 can be coupled to a port portion of the liquid accommodation container 18. The collection port portion 72 is configured such that the collection port portion 72 can be coupled to the pouring port portion 53. The liquid collection container 70 collects the liquid IL in the liquid accommodation container 18 through the collection port portion 72 and the pouring port portion 53 coupled to each other.

In addition, the liquid collection container 70 includes the second identification portion 75 provided near the collection port portion 72. The second identification portion 75 has an uneven shape corresponding to the first identification portion 63 of the liquid accommodation container 18. The second identification portion 75 is configured in a shape that can be engaged with the first identification portion 63 when the collection port portion 72 and the pouring port portion 53 match each other. A user can identify that the collection port portion 72 and the pouring port portion 53 match each other in terms of liquid type (color) when the second identification portion 75 and the first identification portion 63 can be engaged with each other. Note that the details of the second identification portion 75 will be described later.

The pressure generator 80 generates a pressure required to collect the liquid IL in the liquid accommodation container 18 into the liquid collection container 70. The pressure generator 80 of the present embodiment generates a pressure to be introduced into the liquid collection container 70. The pressure generator 80 generates a negative pressure as the pressure. The pressure generator 80 introduces the generated negative pressure into the liquid collection container 70. The pressure generator 80 makes the pressure in the liquid collection container 70 negative.

The pressure generator 80 is provided separately from the liquid collection container 70. The pressure generator 80 is configured to be attachable to and detachable from the liquid collection container 70 into which a pressure is to be introduced. One pressure generator 80 is provided for the plurality of (N) liquid collection containers 70. The pressure generator 80 is used for all of the plurality of liquid collection containers 70 by being attached to and detached from the plurality of liquid collection containers 70.

The pressure generator 80 generates a pressure that causes a liquid in the liquid accommodation container 18 to move into the liquid collection container 70 through a port portion on a liquid accommodation container 18 side and the collection port portion 72 coupled to each other. The pressure generator 80 generates a negative pressure in the liquid collection container 70 so that the liquid in the liquid accommodation container 18 is sucked into the liquid collection container 70.

The pressure generator 80 includes a main body 81. The main body 81 may have a columnar shape, for example. The main body 81 may have the same diameter as the container main body 71. The main body 81 may be coupled to the bottom portion of the container main body 71 in a state of being coaxial with the bottom portion. The main body 81 may have a rectangular parallelepiped-like shape. The pressure generator 80 includes a coupling portion 82, a gas discharge portion 83, and an operation switch 84 provided at the main body 81.

The coupling portion 82 is a portion to be coupled to the bottom portion of the liquid collection container 70. The coupling portion 82 is provided at one surface of the main body 81. The coupling portion 82 is a portion through which a pressure generated by the pressure generator 80 is output. The coupling portion 82 may be a pipe portion protruding from a surface of the main body 81. A pressure generated by the pressure generator 80 is introduced into the liquid collection container 70 via the coupling portion 82.

The gas discharge portion 83 is provided at one surface of the main body 81. The gas discharge portion 83 is a portion through which air sucked through the coupling portion 82 is discharged. The gas discharge portion 83 may be a pipe portion protruding from the main body 81.

The operation switch 84 is provided at one surface of the main body 81. The operation switch 84 may be provided at a surface of the main body 81 that is different from the surface at which the coupling portion 82 is provided. The operation switch 84 is provided at such a position that the operation switch 84 can be operated even in a state where the pressure generator 80 is coupled to the liquid collection container 70. A configuration in which the operation switch 84 switches between an ON state and an OFF state each time the operation switch 84 is pressed once may also be adopted. A configuration in which the operation switch 84 switches between the ON state and the OFF state when a sliding type switching operation or a seesaw type switching operation is performed may also be adopted.

The pipe member 90 is configured such that the pipe member 90 can be coupled to the collection port portion 72. The pipe member 90 has a predetermined length. The pipe member 90 has a length enough to suck a liquid near a bottom surface in the liquid accommodation container 18 in a state where the collection port portion 72 of the liquid collection container 70 is coupled to the pouring port portion 53.

The pipe member 90 is configured such that the pipe member 90 can be coupled to the collection port portion 72. The pipe member 90 has a predetermined length. The pipe member 90 has a length enough to suck a liquid near a bottom surface in the liquid accommodation container 18 in a state where the collection port portion 72 of the liquid collection container 70 is coupled to the pouring port portion 53.

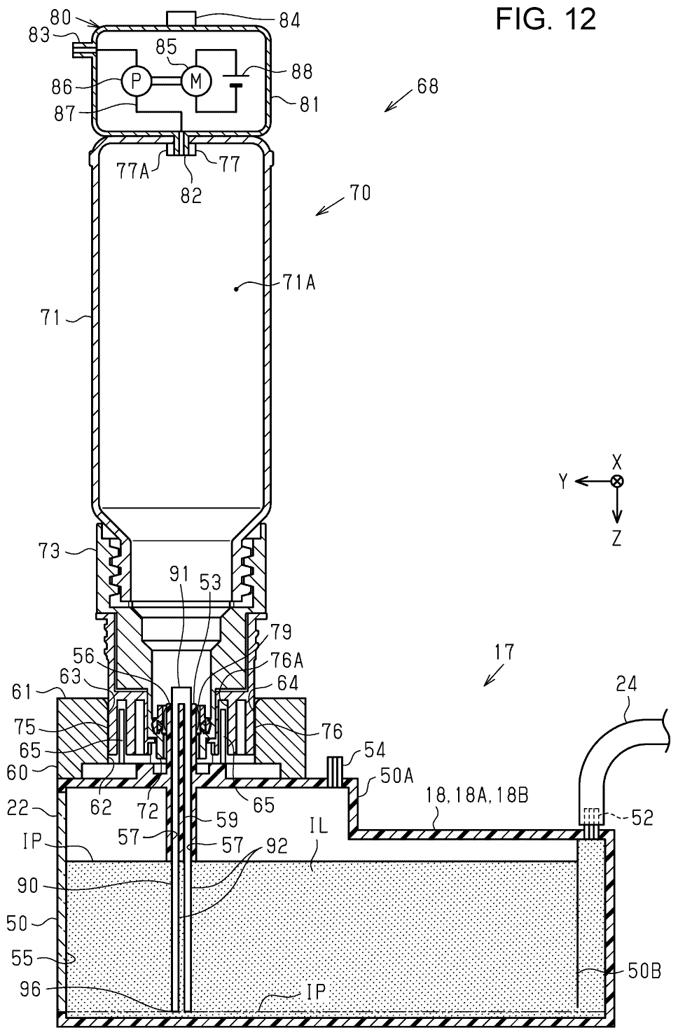

Next, the configuration of the liquid collecting device 68 will be described in details with reference to FIGS. 7 and 8. Note that in the drawings related to the liquid collecting device 68, a coordinate system as follows is used. An X1Y1Z1 coordinate system in FIGS. 7, 8, and 11 is defined in accordance with an XYZ coordinate system regarding a case where the liquid collection container 70 is in a posture shown in FIG. 12 in which the liquid collection container 70 is coupled to the pouring port portion 53 of the liquid accommodation container 18. An axial direction of the liquid collection container 70 will be referred to as a Z1 direction, a direction in which the second identification portion 75 extends will be referred to as a Y1 direction, and a direction orthogonal to the Y1 direction and the Z1 direction will be referred to as an X1 direction.

In the following description, the one set of the components of the liquid collecting device 68 will be described. The one set of the components of the liquid collecting device 68 includes one liquid collection container 70, one pressure generator 80, and one pipe member 90. As shown in FIGS. 7 and 8, the liquid collecting device 68 includes the liquid collection container 70, the pressure generator 80, and the pipe member 90.

The liquid collection container 70 includes the container main body 71 having a bottomed cylindrical shape, a covering portion 73 that covers an upper portion of the container main body 71, and a head portion 74 is covered by an upper portion of the covering portion 73. The covering portion 73 and the head portion 74 cover the upper portion of the container main body 71 in a state where the collection port portion 72 is exposed at an upper end portion.

The plurality of (in FIG. 7, one) liquid collection containers 70 include the second identification portions 75 composed of second uneven portions 76 having different shapes respectively corresponding to the types of liquids to be collected, the second identification portions 75 being provided near the collection port portions 72. In the present embodiment, the plurality of liquid collection containers 70 include the second identification portions 75 composed of the second uneven portions 76 having different shapes respectively corresponding to colors, the second identification portions 75 being provided near the collection port portions 72.

The second identification portion 75 is formed in a shape that can be engaged with the first uneven portion 64 only when the type of a liquid accommodated in the liquid accommodation container 18 and the type of a liquid to be collected into the liquid collection container 70 are the same as each other. In the present embodiment, the second identification portion 75 is formed in a shape that can be engaged with the first uneven portion 64 only when the color of a liquid accommodated in the liquid accommodation container 18 and the color of a liquid to be collected into the liquid collection container 70 are the same as each other. That is, identification of the type of a liquid may be identification of the color of the liquid when the liquid is an ink.

The second identification portion 75 is disposed near the collection port portion 72 of the head portion 74. The second identification portion 75 includes the second uneven portion 76. The second uneven portion 76 has recess portions 76A that can be fitted to the projection portions 65 of the first uneven portion 64 (refer to FIGS. 4 and 5). The recess portions 76A are provided at positions at which the recess portions 76A can be engaged with the projection portions 65, are provided to have such sizes and shapes that the recess portions 76A can be engaged with the projection portions 65, and are provided such that the number of recess portions 76A enables engagement between the recess portions 76A and the projection portions 65. Therefore, when the collection port portion 72 and the pouring port portion 53 that are the same as each other in liquid type (color type) match each other, the second uneven portion 76 can be engaged with the first uneven portion 64. Here, the engagement means that the first uneven portion 64 and the second uneven portion 76 mesh with each other.

As shown in FIG. 7, the liquid collection container 70 includes a screw portion 74A. The screw portion 74A is formed at a lower outer periphery of the head portion 74. The liquid collection container 70 may include a cap 78 that covers the head portion 74. The cap 78 is configured such that a screw portion (not shown) formed at an inner peripheral surface thereof can be screwed onto the screw portion 74A. In addition, the head portion 74 may include a restriction surface 74B that restricts the depth of insertion of the collection port portion 72 with respect to the through-hole 62 and the depth of insertion of the second identification portion 75 with respect to the first identification portion 63.

The pressure generator 80 generates a negative pressure as a pressure that moves the liquid IL in a direction from the liquid accommodation container 18 to the liquid collecting device 68. The pressure generator 80 generates a negative pressure in the liquid collection container 70 to which the pressure generator 80 is coupled by discharging air in the liquid collection container 70. Due to the negative pressure in the liquid collection container 70, the liquid IL in the liquid accommodation container 18 moves to the liquid collecting device 68 through the pouring port portion 53 and the collection port portion 72 coupled to each other.

Next, the internal configuration of the pressure generator 80 will be described with reference to FIG. 8. As shown in FIG. 8, the pressure generator 80 includes a motor 85 which is a driving source, and a pump 86. The motor 85 is a driving source of the pump 86. The motor 85 drives the pump 86. The pump 86 sends air in one direction to make the pressure in a space, from which the air is sent, negative.

The pressure generator 80 includes a flow path 87 that couples the coupling portion 82 and the gas discharge portion 83 to each other. The pump 86 is coupled to the flow path 87. The pump 86 discharges, through the gas discharge portion 83, air that is sucked from the coupling portion 82 through the flow path 87.

A battery 88 is built into the pressure generator 80. The motor 85 is driven with the battery 88 serving as a power source. When the operation switch 84 is turned on, power from the battery 88 is supplied to the motor 85 so that the motor 85 is driven. When the operation switch 84 is turned off, the supply of the power from the battery 88 to the motor 85 is stopped so that the driving of the motor 85 is stopped. While the motor 85 is being driven, a rotational force of the motor 85 is transmitted to the pump 86. The pump 86 performs a pumping operation by means of the rotational force transmitted from the motor 85. That is, the pump 86 performs a pumping operation of discharging, through the gas discharge portion 83, air sucked from the coupling portion 82.

The liquid collection container 70 includes the coupling target portion 77 provided at the bottom portion. The coupling target portion 77 is configured such that the coupling portion 82 of the pressure generator 80 can be coupled to the coupling target portion 77. The coupling target portion 77 includes the valve portion 77A. The valve portion 77A is opened when the coupling portion 82 is inserted, and is closed when the coupling portion 82 is pulled out. In a state where the coupling portion 82 is coupled to the coupling target portion 77, a suction port of the pump 86 and a collection chamber 71A in the liquid collection container 70 communicate with each other.

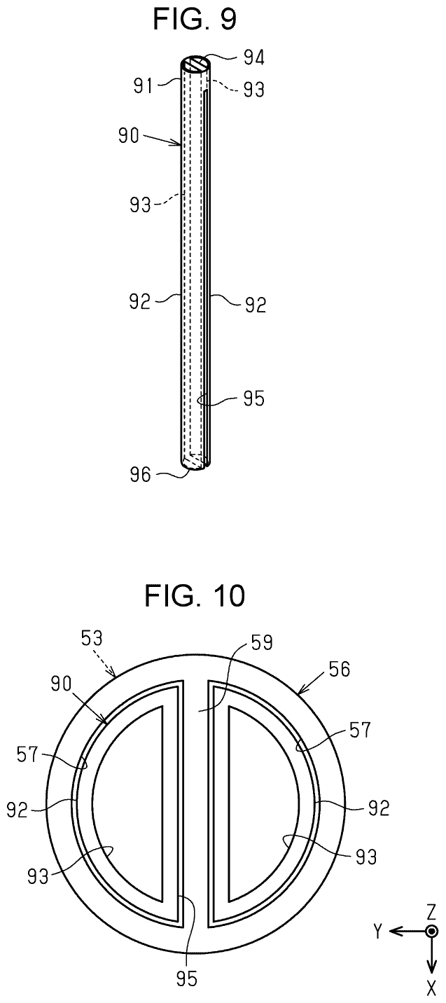

As shown in FIGS. 8 and 9, the pipe member 90 has a predetermined length. The pipe member 90 includes a base portion 91 and two pipe portions 92. The two pipe portions 92 branch off from the base portion 91. That is, the base portion 91 is a portion that couples the two pipe portions 92 to each other. The two pipe portions 92 extend to be parallel to each other. The base portion 91 of the pipe member 90 can be inserted into the collection port portion 72. The base portion 91 can be inserted into the collection port portion 72 up to a predetermined depth at which the base portion 91 can open a valve portion 79.

As shown in FIG. 9, the pipe member 90 includes two flow paths 93. The two flow paths 93 penetrate the inside of each of the base portion 91 and the two pipe portions 92. The base portion 91 includes a partition wall portion 94 that separates the two flow paths 93 from each other. The two pipe portions 92 extend to be parallel to each other with a slit 95 interposed therebetween. At a tip end 96 on a side opposite to the base portion 91 of the pipe member 90, one end of each of the two flow paths 93 is open. The base portion 91 of the pipe member 90 can be coupled to the collection port portion 72. The pipe member 90 is configured such that the two pipe portions 92 (refer to FIG. 4) can be inserted into two flow paths 57 of the pouring port portion 53 from a tip end 96 side.

FIG. 10 is a view showing a state after insertion of the pipe member 90 into the gas-liquid exchange portion 56 as seen from a bottom surface side. As shown in FIG. 10, the two pipe portions 92 have cross-sectional shapes similar to the cross-sectional shapes of the two flow paths 57 constituting the gas-liquid exchange portion 56. The two pipe portions 92 have external shape sizes slightly smaller than the external shape sizes of the two flow paths 57. The partition wall portion 59 that separates the two flow paths 57 from each other is inserted into the slit 95. Therefore, the two pipe portions 92 can penetrate the two flow paths 57.

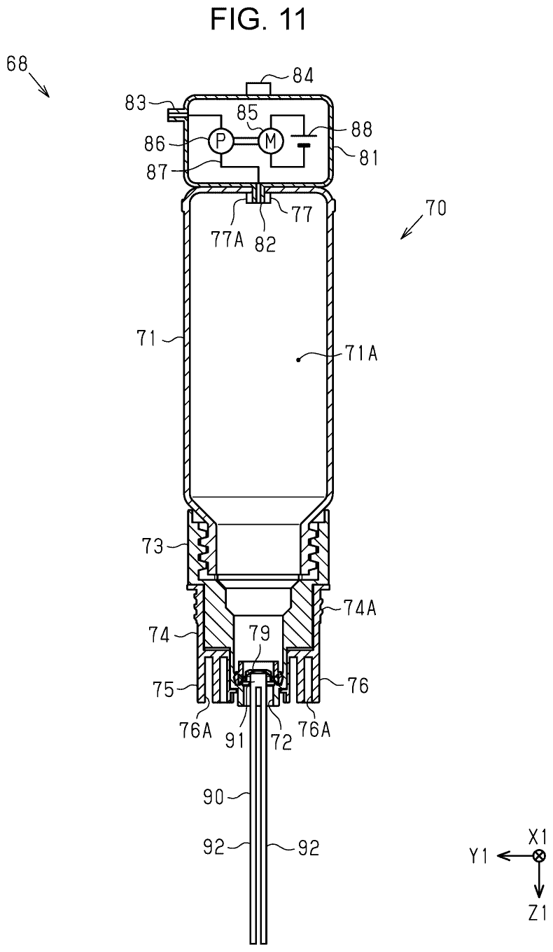

As shown in FIG. 11, the pressure generator 80 is configured such that the pressure generator 80 can be coupled to a bottom portion of the liquid collection container 70, which is an end portion that is on a side opposite to an end portion on a side on which the collection port portion 72 is positioned. The pressure generator 80 sucks air in the liquid collection container 70 from the bottom portion. The base portion 91 of the pipe member 90 is configured such that the base portion 91 can be coupled to the collection port portion 72 of the liquid collection container 70. In a state as shown in FIG. 11, the base portion 91 of the pipe member 90 is in a temporary coupling state where the base portion 91 is inserted to a position shallower than the predetermined depth at which the base portion 91 opens the valve portion 79. The collection port portion 72 and the base portion 91 may have an engaging portion that can hold the base portion 91 at the collection port portion 72 in the temporary coupling state shown in FIG. 11. Note that a configuration in which there is no temporary coupling state and the base portion 91 is inserted up to the predetermined depth at which the base portion 91 opens the valve portion 79 when the pipe member 90 is coupled to the collection port portion 72 may also be adopted.

As shown in FIG. 12, when the collection port portion 72 of the liquid collection container 70 is coupled to the pouring port portion 53 which is an example of a port portion, the pipe portions 92 of the pipe member 90 coupled to the collection port portion 72 are inserted into the liquid accommodation chamber 55. The two pipe portions 92 penetrate the two flow paths 57 of the gas-liquid exchange portion 56. In addition, the base portion 91 of the pipe member 90 may be inserted, by a force acting when the liquid collection container 70 is coupled to the liquid accommodation container 18, up to the predetermined depth at which the base portion 91 can open the valve portion 79 in the collection port portion 72 from a position corresponding to the temporary coupling state. In a coupling state where the valve portion 79 is opened by the pouring port portion 53, the collection chamber 71A of the liquid collection container 70 and the liquid accommodation chamber 55 communicate with each other via the pipe member 90.

The tip end 96 of the pipe member 90 is inserted to a position close to a bottom surface of the liquid accommodation chamber 55 in comparison with a position at which the liquid surface IP at the maximum height position shown in FIG. 12 is when an amount of the liquid IL corresponding to the maximum capacity of the liquid accommodation container 18 is accommodated in the liquid accommodation container 18. Particularly, in an example shown in FIG. 12, the tip end 96 of the pipe member 90 is positioned in the vicinity of the bottom surface of the liquid accommodation chamber 55. Therefore, the liquid IL in the liquid accommodation chamber 55 can be collected into the collection chamber 71A of the liquid collection container 70 until the position of the liquid surface IP that is represented by a two-dot chain line in FIG. 12 is reached.

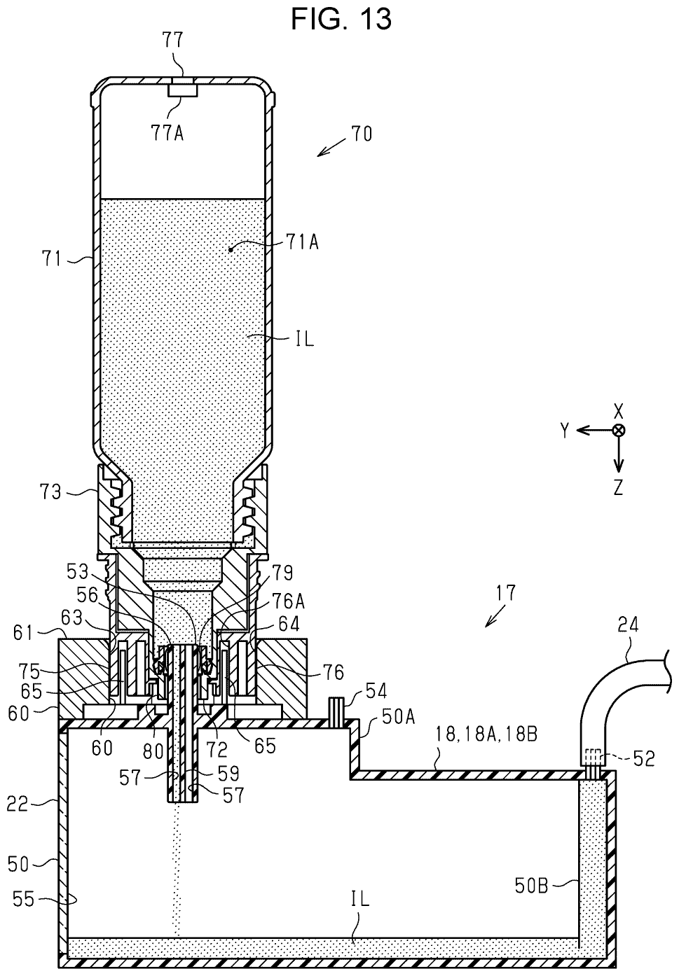

As shown in FIG. 13, the liquid collection container 70 also serves as the supply bottle 34. The collection port portion 72 also serves as a discharge port portion that is coupled to the pouring port portion 53 when a liquid collected into the liquid collection container is to be supplied to the liquid accommodation container 18.

In a state where the liquid collection container 70 is in an inverted posture shown in FIG. 13, the collection port portion 72 is coupled to the pouring port portion 53. The valve portion 79 is opened by the pouring port portion 53. The liquid IL collected into the collection chamber 71A of the liquid collection container 70 communicates with the liquid accommodation chamber 55 through the two flow paths 57. Air in the liquid accommodation chamber 55 is introduced into the liquid collection container 70 through the other of the flow paths 57 while the liquid IL in the liquid collection container 70 is being poured into the liquid accommodation container 18 through one of the two flow paths 57. Due to such gas-liquid exchange, the liquid IL is continuously poured into the liquid accommodation chamber 55 from the inside of the liquid collection container 70. When the liquid surface IP reaches a lower end opening of the gas-liquid exchange portion 56, the gas-liquid exchange is stopped. As a result, the pouring of the liquid IL into the liquid accommodation chamber 55 from the liquid collection container 70 is stopped.

### Actions of First Embodiment

Next, the actions of the liquid collecting device 68 of the first embodiment will be described.

As shown in FIG. 11, a user couples the pressure generator 80 to the bottom portion of the liquid collection container 70. The coupling portion 82 of the pressure generator 80 is coupled to the coupling target portion 77 of the liquid collection container 70. When the coupling portion 82 opens the valve portion 77A, the inside of the collection chamber 71A of the liquid collection container 70 communicates with the pump 86. The user couples the pipe member 90 to the collection port portion 72 of the liquid collection container 70. At this time, the pipe member 90 may be in the temporary coupling state where the base portion 91 is inserted up to a position before the valve portion 79 such that the base portion 91 does not open the valve portion 79. The user inverts the liquid collection container 70 as shown in FIG. 11.

As shown in FIG. 12, the user inserts the pipe member 90 into the pouring port portion 53. The two pipe portions 92 constituting the pipe member 90 are inserted into the two flow paths 57 in the pouring port portion 53. At this time, when the types (for example, colors) of liquids match each other, the first uneven portion 64 and the second uneven portion 76 are engaged with each other. Accordingly, the collection port portion 72 of the liquid collection container 70 is coupled to the pouring port portion 53.

Meanwhile, when the liquid accommodation container 18 from which liquid is to be collected and the liquid collection container 70 do not match each other in terms of liquid type (color), the first uneven portion 64 and the second uneven portion 76 cannot be engaged with each other. Therefore, the user can notice that the liquid accommodation container 18 and the liquid collection container 70 do not match each other in terms of liquid type (color).

As shown in FIG. 12, in a state where the liquid collecting device 68 is coupled to the liquid accommodation container 18, the valve portion 79 is in an opened state with the pouring port portion 53 being inserted into the valve portion 79. At this time, the base portion 91 of the pipe member 90 is also in a state of penetrating the valve portion 79. The base portion 91 of the pipe member 90 comes into contact with a restriction portion (stopper) (not shown) on an inner side of the collection port portion 72, so that the base portion 91 is restricted from further moving to the inner side. That is, the pipe member 90 is positioned at a predetermined position with respect to the collection port portion 72.

Note that a procedure may be adopted in which the pipe member 90 is inserted into the pouring port portion 53 first and the collection port portion 72 of the liquid collection container 70 is coupled to the base portion 91 of the pipe member 90. In such a case, the valve portion 79 is opened when the base portion 91 of the pipe member 90 is inserted into the collection port portion 72 of the liquid collection container 70.

In the coupling state shown in FIG. 12, the tip end 96 of the pipe member 90 is positioned near the bottom surface of the liquid accommodation chamber 55. The length of the pipe member 90 is set such that the tip end 96 is as close as possible to the bottom surface in the liquid accommodation chamber 55. Note that the pressure generator 80 may be coupled to the bottom portion of the liquid collection container 70 after the coupling state.

When the user operates the operation switch 84 in the coupling state shown in FIG. 12, the motor 85 is driven. The pump 86 is driven by the power of the motor 85. Air in the collection chamber 71A is discharged as the pump 86 operates. Therefore, the pressure in the collection chamber 71A of the liquid collection container 70 is made negative. Due to the negative pressure, the liquid IL remaining in the liquid accommodation container 18 is collected into the liquid collection container 70 through the two pipe portions 92 of the pipe member 90.

When the liquid IL in the liquid accommodation container 18 is lowered up to the position of the liquid surface IP represented by the two-dot chain line in FIG. 12, that is, the height position of the tip end 96 of the pipe member 90, air starts to be sucked through openings of the tip end 96 of the pipe member 90. Therefore, collection of the liquid IL that is performed by the pump 86 is stopped. When the user confirms that liquid in the liquid accommodation container 18 has been collected through the visual recognition surface 22, the user turns off the operation switch 84 to stop the operation of the pressure generator 80. When the driving of the motor 85 is stopped, a suction operation of the pump 86 is stopped. When the pump 86 is in a stopped state, the inside of the liquid collection container 70 and the gas discharge portion 83 do not communicate with each other.

After the driving of the pump 86 is stopped, the pressure generator 80 is removed from the liquid collection container 70. In a state after removal of the pressure generator 80, the valve portion 77A at the bottom portion of the liquid collection container 70 is closed. Next, the liquid collection container 70 is removed from the pouring port portion 53. At this time, the base portion 91 of the pipe member 90 moves to such a position that the base portion 91 is pulled out from the valve portion 79. Therefore, when the collection port portion 72 of the liquid collection container 70 is removed from the pouring port portion 53, the valve portion 79 is closed. For example, a configuration in which the pipe member 90 is pulled out together with the liquid collection container 70 with the pipe member 90 coupled to the collection port portion 72 may also be adopted and a configuration in which the liquid collection container 70 is pulled out from the pouring port portion 53 with the pipe member 90 remaining at the pouring port portion 53 may also be adopted.

Thereafter, the pipe member 90 is pulled out from the collection port portion 72 of the liquid collection container 70 or the pipe member 90 remaining at the pouring port portion 53 is pulled out. Since the pipe member 90 is contaminated with a liquid such as an ink, the pipe member 90 may be a disposable product that is discarded after being used once.

The user couples the pressure generator 80 to the bottom portion of the next liquid collection container 70 with a different type (color) of liquid. The pipe member 90 coupled to the collection port portion 72 of the next liquid collection container 70 is inserted into the pouring port portion 53. Hereinafter, the pressure generator 80 is driven with the operation switch 84 operated according to the same procedure, so that the liquid IL in the liquid accommodation container 18 is sucked into the liquid collection container 70 through the pipe member 90 due to a negative pressure in the liquid collection container 70. In this manner, the liquids IL in all of the liquid accommodation containers 18 are collected into the plurality of liquid collection containers 70.

The liquids collected into the liquid collection containers 70 are reused for the new liquid discharging apparatus 11, or are returned to the liquid accommodation containers 18 of the liquid discharging apparatus 11, from which the liquids have been collected, after transportation or maintenance of the liquid discharging apparatus 11 is finished. As shown in FIG. 13, when the liquid IL collected into the liquid collection container 70 is to be supplied into the liquid accommodation container 18, only the liquid collection container 70 is used. That is, the pressure generator 80 and the pipe member 90 are not used.

As shown in FIG. 13, the collection port portion 72 of the liquid collection container 70 is coupled to the pouring port portion 53. When colors match each other, the liquid collection container 70 and the liquid accommodation container 18 can be coupled to each other with the first identification portion 63 and the second identification portion 75 engaged with each other. In such a coupling state, the pouring port portion 53 opens the valve portion 79. The liquid IL in the liquid collection container 70 is supplied into the liquid accommodation container 18 via the gas-liquid exchange portion 56.

### Effects of First Embodiment

According to the first embodiment, the following effects can be obtained.

1-1. The liquid collecting device 68 collects the liquid IL remaining in the liquid accommodation container 18. The liquid accommodation container 18 includes the plurality of port portions 52 to 54 including the pouring port portion 53 and the supply port portion 52. The pouring port portion 53 is a port portion through which a liquid can be poured. The supply port portion 52 is a port portion through which the liquid can be supplied to the liquid discharger 23 that discharges the liquid. The liquid collecting device 68 includes the liquid collection container 70 and the pressure generator 80. The liquid collection container 70 includes the collection port portion 72 configured such that the collection port portion 72 can be coupled to a port portion of the liquid accommodation container 18. The pressure generator 80 is provided separately from the liquid collection container 70 and generates a pressure that causes the liquid IL in the liquid accommodation container 18 to move into the liquid collection container 70 through the port portion and the collection port portion 72 coupled to each other.

According to this configuration, since the liquid collection container 70 and the pressure generator 80 are provided separately from each other, the pressure generator 80 can be coupled to an appropriate pressure introduction destination regardless of the position of coupling of the liquid collection container 70 with respect to the liquid accommodation container 18 and a pressure can be introduced into the appropriate pressure introduction destination. In addition, for example, in a case where there are a plurality of (N (however, N is a natural number satisfying N>1)) the liquid collection containers 70, M (M<N) pressure generators 80 are enough when the pressure generator 80 is used for two or more liquid collection containers 70, where M is smaller than N. For example, the liquid collection container 70 can be prepared for each type of liquid (for example, color) and the pressure generator 80 can be reused by being coupled to a plurality of the liquid collection containers 70. For example, one pressure generator 80 (M=1) is enough. Therefore, the liquid IL remaining in the liquid accommodation container 18 can be efficiently collected.

1-2. The pressure generator 80 is configured to be attachable to and detachable from at least one of the liquid collection container 70 and the liquid accommodation container 18 to which a pressure is to be introduced. According to this configuration, at the time of collection of a liquid, the pressure generator 80 may be attached to at least one of the liquid collection container 70 and the liquid accommodation container 18 to which a pressure is to be introduced. Since the pressure generator 80 and the liquid collection container 70 are separate components, the degree of freedom in selecting a target to which the pressure generator 80 is coupled or the like is increased.

1-3. The collection port portion 72 is configured such that the collection port portion 72 can be coupled to the pouring port portion 53. The liquid collection container 70 collects a liquid in the liquid accommodation container 18 through the collection port portion 72 and the pouring port portion 53 coupled to each other. According to this configuration, the liquid collection container 70 collects the liquid through the pouring port portion 53 and thus it is not necessary to separately form, in the liquid accommodation container 18, a discharge port dedicated for collection.

1-4. The pipe member 90 that is configured such that the pipe member 90 can be coupled to the collection port portion 72 is provided. When the collection port portion 72 is coupled to the port portion, the pipe member 90 coupled to the collection port portion 72 is inserted up to a position that is closer to a bottom surface than the maximum liquid level in the liquid accommodation container 18 is. According to this configuration, the pipe member 90 is inserted into a liquid remaining in the liquid accommodation container 18, so that the liquid in the liquid accommodation container 18 can be collected into the liquid collection container 70 through the pipe member 90.

1-5. The pressure generator 80 generates a negative pressure in the liquid collection container 70. A liquid in the liquid accommodation container 18 is sucked into the liquid collection container 70 due to the negative pressure. According to this configuration, the liquid in the liquid accommodation container 18 can be collected by being sucked into the liquid collection container 70 due to the negative pressure in the liquid collection container 70.

1-6. The pressure generator 80 is configured such that the pressure generator 80 can be coupled to a bottom portion of the liquid collection container 70, which is an end portion that is on a side opposite to an end portion on a side on which the collection port portion 72 is positioned. The pressure generator 80 sucks air in the liquid collection container 70 from the bottom portion. According to this configuration, it is possible to collect a large amount of liquid into the liquid collection container 70 while restraining the pressure generator 80 from sucking a liquid. In addition, the liquid collection container 70 and the pressure generator 80 can be easily attached and detached.

1-7. A plurality of the liquid accommodation containers 18 are provided to be capable of accommodating different types of liquids. A plurality of the liquid collection containers 70 are provided to respectively correspond to the types of liquids to be collected from the liquid accommodation containers 18. The pressure generator 80 is used for all of the plurality of liquid collection containers 70 by being attached to and detached from the plurality of liquid collection containers 70. According to this configuration, the pressure generator 80 can be used for all of the plurality of liquid collection containers 70. Therefore, the number of components of the liquid collecting device 68 can be reduced.

1-8. The type of a liquid is the color of the liquid. The plurality of liquid accommodation containers 18 include the first identification portions 63 composed of the first uneven portions 64 having different uneven shapes respectively corresponding to the colors of the liquids to be accommodated, the first identification portions 63 being provided near the pouring port portions 53. The plurality of liquid collection containers 70 include the second identification portions 75 composed of the second uneven portions 76 having different uneven shapes respectively corresponding to the colors of liquids to be collected, the second identification portions 75 being provided near the collection port portions 72. The first identification portion 63 and the second identification portion 75 are formed in such shapes that the first uneven portion 64 and the second uneven portion 76 are engageable with each other only when the color of a liquid accommodated in the liquid accommodation container 18 and the color of a liquid to be collected into the liquid collection container 70 are the same as each other. According to this configuration, a liquid can be collected into the liquid collection container 70 such that a liquid having a wrong color is not collected thereinto. Since it is possible to prevent liquids having different colors from being mixed in the liquid collection container 70, a collected liquid can be reused.

1-9. The collection port portion 72 also serves as a discharge port portion that is coupled to the pouring port portion 53 when a liquid collected into the liquid collection container 70 is to be supplied to the liquid accommodation container 18. According to this configuration, the liquid collection container 70 can be used as a liquid supply container. The liquid collected into the liquid collection container 70 can be reused by being supplied to the liquid accommodation container 18.

### Second Embodiment

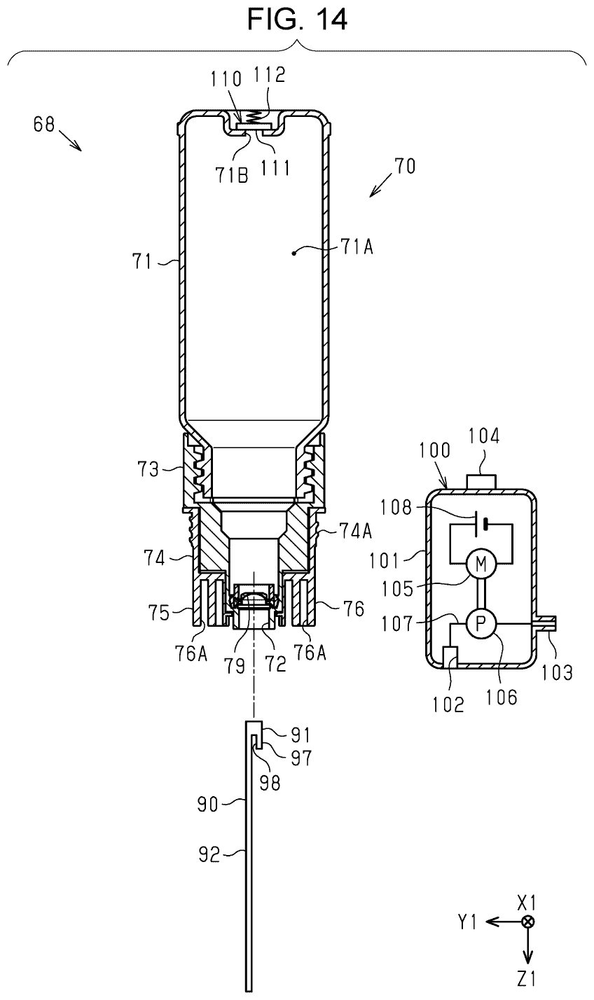

Next, the liquid collecting device 68 of a second embodiment will be described with reference to FIGS. 14 to 17. In the present embodiment, a pressure generator 100 different from the pressure generator 80 of the above-described first embodiment is provided. Note that the configuration of the liquid discharging apparatus 11 is the same as that of the above-described first embodiment. Therefore, the same reference numerals are given to the same members as in the first embodiment, and the detailed description thereof will be omitted. Hereinafter, the configuration of the liquid collecting device 68 of the second embodiment will be described focusing on differences.

The liquid collecting device 68 of the second embodiment collects the liquid IL remaining in the liquid accommodation container 18 as with the above-described first embodiment. The liquid collecting device 68 includes the liquid collection container 70 and the pressure generator 100. The configuration of the liquid collection container 70 is basically the same as that of the liquid collection container 70 of the first embodiment. In addition, as with the above-described first embodiment, the liquid collecting device 68 may include the plurality of (N) liquid collection containers 70 of which the number is equal to the number of the liquid accommodation containers 18. The plurality of liquid collection containers 70 may be provided to respectively correspond to the types (for example, the colors) of liquids accommodated in the liquid accommodation containers 18.

The shapes, structures, and capacities of the liquid collection container 70 are basically the same as those in the above-described first embodiment. The liquid collection containers 70 include the container main bodies 71 and the collection port portions 72. The liquid collection containers 70 include the covering portions 73 and the head portions 74. The liquid collection containers 70 include the same second identification portions 75 as those in the first embodiment, the second identification portions 75 being provided near the pouring port portions 53. That is, the liquid collection containers 70 include the second identification portions 75 composed of second uneven portions 76 having different uneven shapes respectively corresponding to the types (for example, the colors) of liquids to be collected, the second identification portions 75 being provided near the collection port portions 72. The second identification portion 75 has the same shape as that shown in FIG. 7. The second identification portion 75 has a shape corresponding to the first identification portion 63 on the liquid accommodation container 18 side. The second identification portion 75 includes the second uneven portion 76 that can be engaged with the first uneven portion 64 constituting the first identification portion 63. The collection port portion 72 of the liquid collection container 70 is coupled to one of the plurality of port portions 52 to 54 of the liquid accommodation container 18. In the present embodiment, the collection port portion 72 of the liquid collection container 70 is coupled to the pouring port portion 53 of the liquid accommodation container 18.

The liquid collecting device 68 may include the pipe member 90. The pipe member 90 is configured such that the pipe member 90 can be coupled to the pouring port portion 53 of the liquid collection container 70. The pipe member 90 has a predetermined length. The predetermined length is a length that enables the tip end 96 of the pipe member 90 to reach a position near the bottom surface of the liquid accommodation chamber 55 when the pipe member 90 coupled to the collection port portion 72 of the liquid collection container 70 is inserted through the pouring port portion 53. The predetermined length may be a length that enables the tip end 96 to reach a position closer to the bottom surface of the liquid accommodation chamber 55 than to the liquid surface IP positioned at the maximum height position in the liquid accommodation chamber 55.

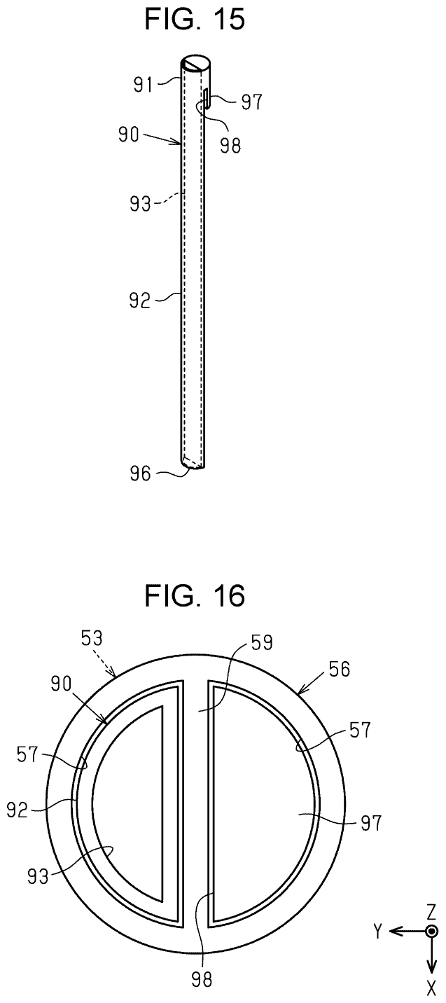

The pressure generator 100 is provided separately from the liquid collection container 70. One pressure generator 100 is provided for the plurality of (N) liquid collection containers 70. The pressure generator 100 is used for all of the plurality of liquid accommodation containers 18 by being attached to and detached from the plurality of liquid accommodation containers 18. The pressure generator 100 of the present embodiment is configured such that the pressure generator 100 can be attachable to and detachable from the liquid accommodation containers 18. The pressure generator 100 introduces a pressure into the liquid accommodation container 18. The pressure generator 100 generates a pressure that causes the liquid IL in the liquid accommodation container 18 to move into the liquid collection container 70 through a port portion of the liquid accommodation container 18 and the collection port portion 72 coupled to each other. The pressure generator 100 is coupled to one of the plurality of port portions 52 to 54 of the liquid accommodation container 18 other than the pouring port portion 53, to which the collection port portion 72 is coupled, such that a positive pressure can be introduced thereinto. The pressure generator 100 may be coupled to the atmosphere communication port portion 54 (refer to FIG. 15) of the liquid accommodation container 18.

The pressure generator 100 introduces a positive pressure into the liquid accommodation chamber 55 by sending air into the liquid accommodation chamber 55 through the atmosphere communication port portion 54. The pressure generator 100 pressurizes the liquid surface IP in the liquid accommodation container 18 through the atmosphere communication port portion 54. The pressure generator 100 pressurizes the liquid surface IP so that the liquid IL in the liquid accommodation container 18 is sent into the liquid collection container 70 through the pouring port portion 53 and the collection port portion 72 coupled to each other.

The liquid collection container 70 includes a relief valve 110 that releases, to the outside, an amount of air corresponding to the amount of the liquid IL flowing into the liquid collection container 70 due to pressurization of the liquid surface IP in the liquid accommodation container 18. The relief valve 110 is provided at the bottom portion of the liquid collection container 70. The relief valve 110 includes a valve hole 71B that is open at the bottom portion of the container main body 71, a valve body 111 that can open and close the valve hole 71B, and a spring 112 that urges the valve body 111 in a valve closing direction. The relief valve 110 is opened when the air pressure in the collection chamber 71A of the liquid collection container 70 exceeds a predetermined value.

As shown in FIG. 14, the pressure generator 100 includes a main body 101. The pressure generator 100 includes a coupling portion 102, a gas suction portion 103, and an operation switch 104. The coupling portion 102 is a portion coupled to the atmosphere communication port portion 54, which is an example of the port portions of the liquid accommodation container 18. The gas suction portion 103 is a portion through which air is sucked.

As shown in FIG. 14, the pressure generator 100 includes a motor 105 which is a driving source, and a pump 106. The motor 105 is a driving source of the pump 106. The motor 105 drives the pump 106. The pump 106 sends air in one direction to send the air to the liquid accommodation container 18 to which the pressure generator 100 is coupled. The pump 106 pressurizes the inside of the liquid accommodation container 18 to which the pressure generator 100 is coupled.

The pressure generator 100 includes a flow path 107 that couples the coupling portion 102 and the gas suction portion 103 to each other. The pump 106 is coupled to the flow path 107. The pump 106 sends air sucked through the gas suction portion 103 to the liquid accommodation container 18 to which the pressure generator 100 is coupled, through the coupling portion 102.

A battery 108 is built into the pressure generator 100. The motor 105 is driven with the battery 108 serving as a power source. When the operation switch 104 is turned on, power from the battery 108 is supplied to the motor 105 so that the motor 105 is driven. When the operation switch 104 is turned off, the supply of the power from the battery 108 to the motor 105 is stopped so that the driving of the motor 105 is stopped. The pump 106 is driven while the motor 105 is being driven. The pump 106 performs a pumping operation by means of a rotational force of the motor 105. That is, the pump 106 performs a pumping operation of discharging, through the coupling portion 102, air sucked from the gas suction portion 103.

As shown in FIG. 15, the pipe member 90 includes the base portion 91, one pipe portion 92, and a plug portion 97. The pipe portion 92 and the plug portion 97 are separated from each other with a slit 98 interposed therebetween. The one pipe portion 92 is inserted into one of the two flow paths 57 of the gas-liquid exchange portion 56. One plug portion 97 closes the other of the two flow paths 57 of the gas-liquid exchange portion 56. Therefore, when the liquid IL remaining in the liquid accommodation container 18 is pressurized, the pipe member 90 transfers the liquid IL into the liquid collection container 70 through one flow path 93 penetrating the one pipe portion 92. Gas-liquid exchange is not performed at the time of collection of a liquid. The air pressure in the collection chamber 71A increases in accordance with the amount (the volume) of the liquid IL collected into the liquid collection container 70. The relief valve 110 is opened when the air pressure in the collection chamber 71A exceeds the predetermined value, so that the air pressure in the collection chamber 71A is maintained at an air pressure equal to or lower than a predetermined air pressure. Therefore, the liquid IL is continuously collected into the liquid collection container 70 even when gas-liquid exchange is not performed at the gas-liquid exchange portion 56.

FIG. 16 is a view showing a state after insertion of the pipe member 90 into the gas-liquid exchange portion 56 as seen from the bottom surface side. As shown in FIG. 16, the one pipe portion 92 has a cross-sectional shape similar to the cross-sectional shapes of the flow paths 57 of the gas-liquid exchange portion 56 as with the above-described first embodiment. The pipe portion 92 has an external shape size slightly smaller than the external shape sizes of the flow paths 57. The partition wall portion 59 that separates the two flow paths 57 from each other is inserted into the slit 98. The one pipe portion 92 can penetrate the one flow path 57. The one plug portion 97 can close one flow path 57.

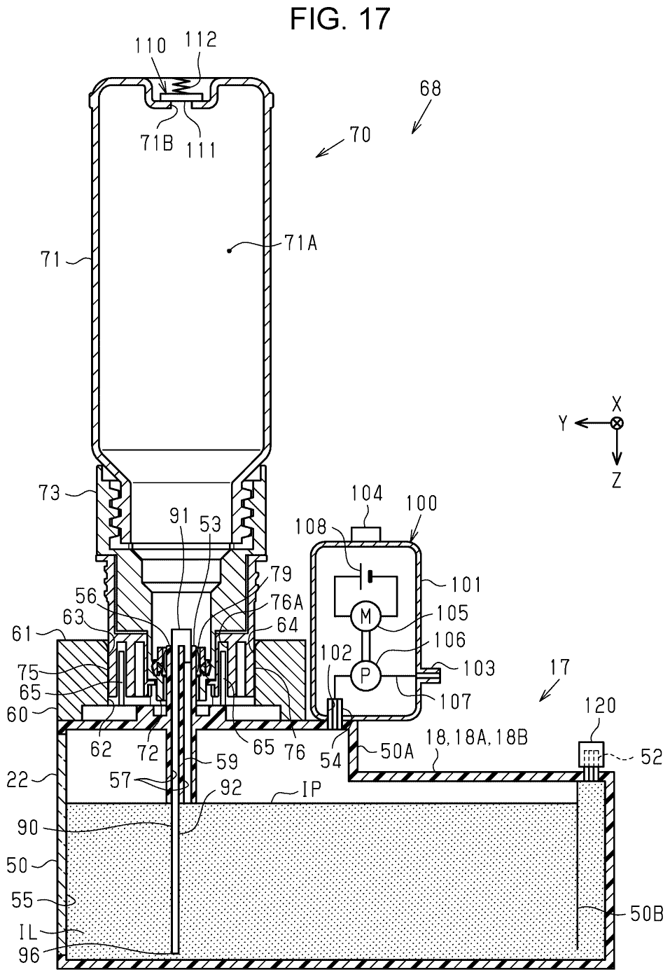

As shown in FIG. 17, when the collection port portion 72 of the liquid collection container 70 is coupled to the pouring port portion 53 which is an example of a port portion, the one pipe portion 92 of the pipe member 90 coupled to the collection port portion 72 is inserted into the liquid accommodation chamber 55. The valve portion 79 is opened by the pouring port portion 53. The tip end 96 of the pipe member 90 is inserted to a position close to the bottom surface of the liquid accommodation chamber 55 in comparison with a position at which the liquid surface IP at the maximum height position shown in FIG. 17 is when an amount of the liquid IL corresponding to the maximum capacity of the liquid accommodation container 18 is accommodated in the liquid accommodation container 18. Particularly, in an example shown in FIG. 17, the tip end 96 of the pipe member 90 is positioned in the vicinity of the bottom surface of the liquid accommodation chamber 55.

The coupling portion 102 of the pressure generator 100 is coupled to the atmosphere communication port portion 54 of the liquid accommodation container 18. A lid member 120 (a cap member) is mounted to the supply port portion 52, which is one of the plurality of port portions 52 to 54 of the liquid accommodation container 18 other than the port portions 53 and 54 to be coupled to the liquid collection container 70 and the pressure generator 100. Therefore, an air area in the liquid accommodation chamber 55 is in a state of being substantially airtightly sealed. When the pressure generator 100 is driven in such a state, air is sent from the pressure generator 100 into the liquid accommodation chamber 55, so that the liquid surface IP in the liquid accommodation chamber 55 is pressurized.

### Actions of Second Embodiment

The actions of the second embodiment will be described. A user attaches the pipe member 90 to the collection port portion 72 of the liquid collection container 70. The pipe member 90 is inserted into the pouring port portion 53 with the liquid collection container 70 being in an inverted posture. The one pipe portion 92 penetrates the flow path 57 and the tip end 96 thereof is positioned in the vicinity of the bottom surface of the liquid accommodation chamber 55. In addition, the plug portion 97 closes another flow path 57. Therefore, the collection chamber 71A of the liquid collection container 70 and the liquid accommodation chamber 55 communicate with each other through the one pipe portion 92.

In addition, the user couples the coupling portion 102 of the pressure generator 100 to the atmosphere communication port portion 54. In addition, the user seals the supply port portion 52 by mounting the lid member 120 to the supply port portion 52. The air area in the liquid accommodation chamber 55 enters a state of being substantially airtightly sealed.

When the user operates the operation switch 104 in such a state, the motor 105 is driven. The pump 106 sends air into the liquid accommodation chamber 55 by means of the power of the motor 105. Accordingly, the pressure in the air area in the liquid accommodation chamber 55 above the liquid surface IP is made positive. Therefore, the liquid surface IP in the liquid accommodation chamber 55 is pressurized. Since the liquid surface IP is pressurized, the liquid IL in the liquid accommodation chamber 55 is sent into the collection chamber 71A of the liquid collection container 70 through the pipe portion 92.

The air pressure in the liquid collection container 70 increases in accordance with the amount of inflow of the liquid IL. When the air pressure exceeds the predetermined value, the relief valve 110 is opened and air is discharged. Accordingly, collection of the liquid IL from the liquid accommodation container 18 into the liquid collection container 70 and discharge of air at the time of an increase in air pressure in the liquid collection container 70 caused due to the collection of the liquid IL are continuously performed.

In addition, when the liquid surface IP in the liquid accommodation container 18 is lowered to the height position of a tip end of the pipe member 90, air is sent through the pipe portion 92 and thus collection of a liquid into the liquid collection container 70 is stopped. In this manner, the liquid collecting device 68 collects substantially the entire amount of the liquid IL remaining in the liquid accommodation container 18.

The user operates the operation switch 104 to stop the driving of the pressure generator 100. The user pulls out the liquid collection container 70 from the pouring port portion 53. At this time, the liquid collection container 70 may be pulled out together with the pipe member 90, or may be pulled out with the pipe member 90 remaining at the pouring port portion 53. In the former case, the valve portion 79 may be closed with the pipe member 90 being relatively lowered with respect to the collection port portion 72 by a force acting when the liquid collection container 70 is pulled out.

During a process of pulling out the liquid collection container 70 from the pouring port portion 53, a tip end of the pipe portion 92 is separated from the liquid surface IP. At this time, the valve portion 79 is closed. Therefore, the collected liquid IL is prevented from flowing out from the liquid collection container 70 via the pipe member 90. In addition, even in a state where the valve portion 79 is opened by the base portion 91 of the pipe member 90, one flow path 57 of the gas-liquid exchange portion 56 is blocked by the plug portion 97 so that gas-liquid exchange is prevented. Therefore, in this case as well, the collected liquid IL can be prevented from flowing out from the liquid collection container 70 via the pipe member 90.

The user couples the pressure generator 100 to the atmosphere communication port portion 54 of the liquid accommodation container 18 from which a liquid is to be collected next. The pipe member 90 coupled to the collection port portion 72 of the next liquid collection container 70 is caused to enter a state of being inserted into the pouring port portion 53. Hereinafter, the pressure generator 100 is driven with the operation switch 104 operated according to the same procedure, so that the liquid IL in the liquid accommodation container 18 is collected into the liquid collection container 70 through the pipe member 90 due to pressurization of the liquid surface IP.

### Effects of Second Embodiment

According to the second embodiment, the effects 1-1. to 1-4., 1-8., and 1-9. in the above-described first embodiment are obtained in a similar manner and the following effects are also obtained.

2-1. The pressure generator 100 pressurizes the liquid surface IP in the liquid accommodation container 18. Due to such pressurization, the liquid IL in the liquid accommodation container 18 is sent into the liquid collection container 70 through a port portion and the collection port portion 72 coupled to each other. According to this configuration, the liquid remaining in the liquid accommodation container 18 can be collected by being sent to the liquid collection container 70 due to pressurization of the liquid surface IP in the liquid accommodation container 18.

2-2. The pressure generator 100 is coupled to one of the plurality of ports other than a port portion, to which the collection port portion 72 is coupled, such that a positive pressure can be introduced thereinto. The liquid collection container 70 includes the relief valve 110 that releases, to the outside, an amount of air corresponding to the amount of a liquid flowing into the liquid collection container 70 due to pressurization of the liquid surface IP in the liquid accommodation container 18. According to this configuration, a liquid can be continuously collected into the liquid collection container 70 since air in the liquid collection container 70 can be released in accordance with the amount of inflow of a liquid.

2-3. A plurality of the liquid accommodation containers 18 are provided to be capable of accommodating different types of liquids. A plurality of the liquid collection containers 70 are provided to respectively correspond to the types of liquids to be collected from the liquid accommodation containers 18. The pressure generator 100 is used for all of the plurality of liquid accommodation containers 18 by being attached to and detached from the plurality of liquid accommodation containers 18. According to this configuration, the pressure generator 100 can be used for all of the plurality of liquid collection containers 70. Therefore, the number of components of the liquid collecting device 68 can be reduced.

Note that the above-described embodiments can be modified as in modification examples as follows. Furthermore, an appropriate combination of the above-described embodiment and a modification example as follows can be adopted as another modification example and an appropriate combination of modification examples as follows may be adopted as still another modification example.
In each of the above-described embodiments, the liquid collecting device 68 may collect the liquid IL remaining in the liquid accommodation container 18 removed from the housing 20.
In each of the above-described embodiments, a port portion other than the port portions 52 to 54, which is dedicated for liquid collection, may be added to the liquid accommodation container 18. The liquid IL remaining in the liquid accommodation container 18 may be collected into the liquid collection container 70 with the collection port portion 72 coupled to the port portion dedicated for liquid collection.
When only collection of a liquid is to be performed, the liquid collection container 70 may accommodate a liquid absorbing member that absorbs the liquid. The liquid absorbing member may be a nonwoven fabric, a porous material such as a sponge, a water absorbent polymer material, or the like.
The number of liquid collection containers 70 may be a number M that is smaller than a number N, the number N being the number of liquid accommodation containers 18. In such a case, the capacity of the liquid collection container 70 may be larger than the maximum capacity of the liquid accommodation container 18. Liquids from the plurality of liquid accommodation containers 18 may be collected into one liquid collection container 70 when the collected liquids are to be discarded. For example, when the number of the liquid accommodation containers 18 is four or five, the number of the liquid collection containers 70 may be two or three. Furthermore, the number of the liquid collection containers 70 may be one. One liquid collection container 70 may have a capacity equal to or larger than the sum of the maximum capacities of the N liquid accommodation containers 18.
The capacity of the liquid collection container 70 may be smaller than the maximum capacity of the liquid accommodation container 18 to which the liquid collection container 70 corresponds in terms of liquid type (for example, color).
In each of the embodiments, a configuration in which the pouring port portion 53 does not include the gas-liquid exchange portion 56 may also be adopted. In such a case, the pipe member 90 may be a pipe-shaped member including only one flow path 93.
A configuration in which the liquid collecting device 68 does not include the pipe member 90 may also be adopted. For example, a configuration in which the gas-liquid exchange portion 56 is replaced with one pipe portion through which only one flow path passes and a lower end of the pipe portion is positioned close to the bottom surface of the liquid accommodation chamber 55 may also be adopted. In the case of such a configuration, almost the entire amount of the liquid IL remaining in the liquid accommodation container 18 can be collected without the pipe member 90.
The pipe member 90 may be inserted up to a depth at which the lower end is positioned closer to the bottom surface than to the maximum liquid level in the liquid accommodation chamber 55. Even in the case of such a configuration, half or more of an amount of the liquid IL corresponding to the maximum capacity of the liquid accommodation container 18 can be collected by means of the liquid collecting device 68 when such an amount of the liquid IL remains in the liquid accommodation container 18 . . . .
In each of the above-described embodiments, the liquid collection container 70 is not limited to a bottle type container. The liquid collection container 70 may be, for example, a box type container, a cartridge type container, a pack type container, or the like.
In the above-described first embodiment, the liquid collection container 70 and the pressure generator 80 may be coupled to each other via a flow path member such as a tube. That is, the coupling portion 82 of the pressure generator 80 and the coupling target portion 77 of the liquid collection container 70 may be coupled via the flow path member.
In the above-described second embodiment, the liquid accommodation container 18 and the pressure generator 100 may be coupled to each other via a flow path member such as a tube. That is, the coupling portion 82 of the pressure generator 100 and a port portion (the atmosphere communication port portion 54) of the liquid accommodation container 18 may be coupled via the flow path member.
In the second embodiment, a port portion to which the coupling portion 102 of the pressure generator 100 is coupled may be the supply port portion 52. In such a case, the atmosphere communication port portion 54 may be sealed with the lid member 120 (cap member).
In each of the above-described embodiments, the supply port portion 52 may be provided at a lower portion of a side surface of the liquid accommodation container 18 instead of being provided at the upper surface of the liquid accommodation container 18 or an upper portion of the side surface of the liquid accommodation container 18. In such a case, the liquid accommodation container 18 may include a valve portion that closes a flow path communicating with the supply port portion 52 when the supply flow path 24 is removed from the supply port portion 52 in the case of the pressurization type liquid collecting device 68 in the second embodiment.
In each of the above-described embodiments, the pumps 86 and 106 of the pressure generators 80 and 100 may be manual pumps that are manually driven instead of electric pumps of which driving sources are the motors 85 and 105. The manual pumps may be, for example, manual pumps that are driven by a manual operation performed by a user, such as an operation of rotating a handle or an operation of causing a lever to reciprocate. For example, the pressure generator 80 of the first embodiment may be configured such that the user manually generates a negative pressure. For example, a syringe or a rubber ball may be used for the manual pumps. In such a case, a configuration in which a coupling portion of the manual-type pressure generator 80 is coupled to the coupling target portion 77 of the liquid collection container 70 may also be adopted.
In each of the above-described embodiments, the liquid collecting device 68 may include both different types of pressure generators 80 and 100 that generate different types of pressures. That is, the liquid collecting device 68 may include both a first pressure generator 80 that is coupled to the liquid collection container 70 and that can generate a negative pressure and a second pressure generator 100 that is coupled to the liquid accommodation container 18 and that can generate a positive pressure. According to this configuration, the liquid IL remaining in the liquid accommodation container 18 can be efficiently collected into the liquid collection container 70 by means of a negative pressure in the liquid collection container 70 and pressurization of the liquid surface IP resulting from a positive pressure in the liquid accommodation container 18 . . . .
A motor of the liquid discharging apparatus 11 may be used as a driving source of the pressure generators 80 and 100. For example, a configuration in which driven portions on a side close to the pressure generators 80 and 100 are coupled to a driving portion that outputs power of the motor in the liquid discharging apparatus 11 may also be adopted. The driving portion and the driven portions may be, for example, a driving gear and driven gears. In such a case, the motor, which is the driving source, may be a transportation motor that is a driving source of a transporter transporting the medium M or a motor that is a driving source of the maintenance device 35. The coupling portion 82 of the pressure generator 80 is coupled to the coupling target portion 77 of the liquid collection container 70 through a tube. The coupling portion 102 of the pressure generator 100 is coupled to a port portion (for example, the atmosphere communication port portion 54) of the liquid accommodation container 18 through a tube.
In each of the above-described embodiments, a configuration in which the valve portion 79 of the liquid collection container 70 switches from a closing position to an opening position as a user performs a manual operation of operating a lever, operating a button, or the like may also be adopted.
Although the liquid discharging apparatus 11 in the above-described embodiments includes the plurality of liquid accommodation containers 18, the liquid discharging apparatus 11 may include only one liquid accommodation container 18. The one liquid accommodation container 18 may accommodate, for example, a black ink as a liquid. That is, the liquid discharging apparatus 11 may be an ink jet printer dedicated for monochrome printing.
The type of a liquid is not limited to the color of the liquid. The liquid discharging apparatus 11 may include the plurality of liquid accommodation containers 18 respectively corresponding to the types of liquids other than the colors thereof. For example, the types of liquids may be the types of the liquids that are distinguished from each other with a difference in pigment or dye of the liquids having the same color.
In the liquid discharging apparatus 11, a position at which the liquid accommodation container 18 is disposed is not limited to a right side of a front portion of the housing 20. For example, a position at which the liquid accommodation container 18 is disposed may be a left side of the front portion of the housing 20. In addition, a position at which the liquid accommodation container 18 is disposed may be a side portion of the housing 20 or a rear portion of the housing 20. In addition, a portion of the housing 20 may serve as the accommodation portion 19 that does not protrude outward (for example, frontward). In addition, the plurality of liquid accommodation containers 18 may be separately disposed on right and left sides of the front portion of the housing 20.
The liquid discharging apparatus 11 is not limited to an ink jet printer that performs printing on a paper sheet and may be a textile printing apparatus that performs printing on a textile.
The medium M onto which the liquid discharging apparatus 11 discharges a liquid may be a synthetic resin film, a laminated medium including a synthetic resin layer and a metal layer, a foil (sheet) made of metal, or the like.
The liquid discharging apparatus 11 may be a liquid discharging apparatus that discharges a liquid other than an ink. Examples of the state of a liquid discharged in the form of a minute amount of liquid droplets from a liquid discharging apparatus include granular, tear-like, and thread-like liquids. The liquid referred herein may be any material as long as the material can be discharged from the liquid discharging apparatus. For example, the liquid may be any substance in a liquid phase and examples thereof include a liquid substance having a high or low viscosity, sol, gel water, and other liquid substances such as an inorganic solvent, an organic solvent, a solution, a liquid resin, or liquid metal (metallic melt). Examples of the liquid include not only a liquid as one state of a substance but also a solvent or the like in which particles of a functional material made of a solid substance, such as a pigment or a metal particle, are dissolved, dispersed, or mixed. Representative examples of the liquid include an ink and a liquid crystal as described in the embodiments described above. Here, examples of the ink include various types of liquid compositions, such as a general water-based ink, an oil-based ink, a gel ink, a hot melt ink, and the like. As a specific example of the liquid discharging apparatus, for example, there is a liquid discharging apparatus that discharges a liquid in which a material, such as an electrode material or a coloring material used for manufacture or the like of a liquid crystal display, an electroluminescence (EL) display, a plane emission display, and a color filter, is contained in a state of being dispersed or dissolved. The liquid discharging apparatus may be an apparatus that discharges a bioorganic material used for manufacture of a biochip, an apparatus that discharges a liquid that serves as a sample used as a precision pipette, a textile printing apparatus, a micro dispenser, or the like. The liquid discharging apparatus may be an apparatus that discharges lubricating oil to a precision machine such as a watch or a camera in a pin-point manner, or an apparatus that discharges a transparent resin liquid such as an ultraviolet curable resin onto a substrate in order to form a micro hemispherical lens (an optical lens) or the like used for an optical communication element or the like. The liquid discharging apparatus may be an apparatus that discharges an acid or alkali etching solution in order to etch a substrate or the like. A technique of collecting a liquid remaining in the liquid accommodation container 18, which has been described in each of the above-described embodiments or each of the modification examples, may be applied to such a liquid discharging apparatus.

Hereinafter, technical concepts understood from the above-described embodiments and the modification examples will be described together with effects thereof.

[1] A liquid collecting device is a liquid collecting device collecting a liquid remaining in a liquid accommodation container including a plurality of port portions including a pouring port portion through which the liquid is poured and a supply port portion through which the liquid is supplied to a liquid discharger that discharges the liquid, the liquid collecting device including a liquid collection container that includes a collection port portion configured to be coupled to a port portion of the liquid accommodation container and a pressure generator that is provided separately from the liquid collection container and that generates a pressure that causes the liquid in the liquid accommodation container to move into the liquid collection container through the port portion and the collection port portion coupled to each other.

According to this configuration, since the liquid collection container and the pressure generator are provided separately from each other, the pressure generator can be coupled to an appropriate pressure introduction destination regardless of the position of coupling of the liquid collection container with respect to the liquid accommodation container and a pressure can be introduced into the appropriate pressure introduction destination. Therefore, the liquid remaining in the liquid accommodation container can be efficiently collected. In addition, for example, in a case where there are a plurality of (N (N is a natural number satisfying N>1)) the liquid collection containers, M (M<N) pressure generators are enough when the pressure generator is used for two or more liquid collection containers, where M is smaller than N. For example, the liquid collection container can be prepared for each type of liquid (for example, color) and the pressure generator can be reused by being coupled to a plurality of the liquid collection containers. For example, one pressure generator (M=1) is enough.

[2] In the liquid collecting device described above in [1], the pressure generator may be configured to be attachable to and detachable from at least one of the liquid collection container and the liquid accommodation container to which the pressure is to be introduced. According to this configuration, at the time of collection of a liquid, the pressure generator may be attached to at least one of the liquid collection container and the liquid accommodation container to which a pressure is to be introduced. Since the pressure generator and the liquid collection container are separate components, the degree of freedom in selecting a target to which the pressure generator is coupled or the like is increased.

[3] In the liquid collecting device described above in [1] or [2], the collection port portion may be configured to be coupled to the pouring port portion, and the liquid collection container may collect the liquid in the liquid accommodation container through the collection port portion and the pouring port portion coupled to each other. According to this configuration, the liquid collection container collects the liquid through the pouring port portion and thus it is not necessary to separately form, in the liquid accommodation container, a discharge port dedicated for collection.

[4] The liquid collecting device described above in any one of [1] to [3] may further include a pipe member configured to be coupled to the collection port portion, and when the collection port portion is coupled to the port portion, the pipe member coupled to the collection port portion may be inserted up to a position that is closer to a bottom surface than a maximum liquid level in the liquid accommodation container is. According to this configuration, the pipe member is inserted into a liquid remaining in the liquid accommodation container, so that the liquid in the liquid accommodation container can be collected into the liquid collection container through the pipe member.

[5] In the liquid collecting device described above in any one of [1] to [4], the pressure generator may generate a negative pressure in the liquid collection container so that the liquid in the liquid accommodation container is sucked into the liquid collection container. According to this configuration, the liquid in the liquid accommodation container can be collected by being sucked into the liquid collection container due to the negative pressure in the liquid collection container.

[6] In the liquid collecting device described above in [5], the pressure generator may be configured to be coupled to a bottom portion of the liquid collection container, which is an end portion that is on a side opposite to an end portion on a side on which the collection port portion is positioned, and may suck air in the liquid collection container from the bottom portion. According to this configuration, it is possible to collect a large amount of liquid into the liquid collection container while restraining the pressure generator from sucking a liquid. In addition, the liquid collection container and the pressure generator can be easily attached and detached.

[7] In the liquid collecting device described above in any one of [1] to [6], the pressure generator may pressurize a liquid surface in the liquid accommodation container so that the liquid in the liquid accommodation container is sent into the liquid collection container through the port portion and the collection port portion coupled to each other. According to this configuration, the liquid remaining in the liquid accommodation container can be collected by being sent to the liquid collection container due to pressurization of the liquid surface in the liquid accommodation container.

[8] In the liquid collecting device described above in [7], the pressure generator may be coupled to one of the plurality of port portions other than the port portion to which the collection port portion is coupled such that a positive pressure is introduced thereinto, and the liquid collection container may include a relief valve that releases, to an outside, an amount of air corresponding to an amount of the liquid flowing into the liquid collection container due to the pressurization of the liquid surface in the liquid accommodation container. According to this configuration, a liquid can be continuously collected into the liquid collection container since air in the liquid collection container can be released in accordance with the amount of inflow of a liquid.

[9] In the liquid collecting device described above in any one of [2] to [8], a plurality of the liquid accommodation containers may be provided to accommodate different types of liquids, a plurality of the liquid collection containers may be provided to respectively correspond to types of liquids to be collected from the liquid accommodation containers, and the pressure generator may be used for all of the plurality of liquid collection containers by being attached to and detached from the plurality of liquid collection containers or be used for all of the plurality of liquid accommodation containers by being attached to and detached from the plurality of liquid accommodation containers. According to this configuration, the pressure generator can be used for all of the plurality of liquid collection containers. Therefore, the number of components of the liquid collecting device can be reduced.

[10] In the liquid collecting device described above in [9], the types of the liquids may be colors of the liquids, the plurality of liquid accommodation containers may include first identification portions composed of first uneven portions having different uneven shapes respectively corresponding to colors of the liquids to be accommodated, each first identification portion being provided near the pouring port portion, the plurality of liquid collection containers may include second identification portions composed of second uneven portions having different uneven shapes respectively corresponding to the colors of the liquids to be collected, each second identification portion being provided near the collection port portion, and the first identification portion and the second identification portion may be formed in such shapes that the first uneven portion and the second uneven portion are engageable with each other only when a color of a liquid accommodated in the liquid accommodation container and a color of a liquid to be collected into the liquid collection container are the same as each other. According to this configuration, a liquid can be collected into the liquid collection container such that a liquid having a wrong color is not collected thereinto. Since it is possible to prevent liquids having different colors from being mixed in the liquid collection container, a collected liquid can be reused.

[11] In the liquid collecting device described above in any one of [1] to [10], the collection port portion may also serve as a discharge port portion that is coupled to the pouring port portion when a liquid collected into the liquid collection container is to be supplied to the liquid accommodation container. According to this configuration, the liquid collection container can be used as a liquid supply container. The liquid collected into the liquid collection container can be reused by being supplied to the liquid accommodation container.

What is claimed is:

1. A liquid collecting device collecting a liquid remaining in a liquid accommodation container including a plurality of port portions including a pouring port portion through which the liquid is poured and a supply port portion through which the liquid is supplied to a liquid discharger that discharges the liquid, the liquid collecting device comprising:
a liquid collection container that includes a collection port portion configured to be coupled to a port portion of the liquid accommodation container; and
a pressure generator that is provided separately from the liquid collection container and that generates a pressure that causes the liquid in the liquid accommodation container to move into the liquid collection container through the port portion and the collection port portion coupled to each other.

2. The liquid collecting device according to claim 1, wherein
the pressure generator is configured to be attachable to and detachable from at least one of the liquid collection container and the liquid accommodation container to which the pressure is to be introduced.

3. The liquid collecting device according to claim 1, wherein
the collection port portion is configured to be coupled to the pouring port portion, and
the liquid collection container collects the liquid in the liquid accommodation container through the collection port portion and the pouring port portion coupled to each other.

4. The liquid collecting device according to claim 1, further comprising:
a pipe member configured to be coupled to the collection port portion, wherein
when the collection port portion is coupled to the port portion, the pipe member coupled to the collection port portion is inserted up to a position that is closer to a bottom surface than a maximum liquid level in the liquid accommodation container is.

5. The liquid collecting device according to claim 1, wherein
the pressure generator generates a negative pressure in the liquid collection container so that the liquid in the liquid accommodation container is sucked into the liquid collection container.

6. The liquid collecting device according to claim 5, wherein
the pressure generator is configured to be coupled to a bottom portion of the liquid collection container, which is an end portion that is on a side opposite to an end portion on a side on which the collection port portion is positioned, and sucks air in the liquid collection container from the bottom portion.

7. The liquid collecting device according to claim 1, wherein
the pressure generator pressurizes a liquid surface in the liquid accommodation container so that the liquid in the liquid accommodation container is sent into the liquid collection container through the port portion and the collection port portion coupled to each other.

8. The liquid collecting device according to claim 7, wherein
the pressure generator is coupled to one of the plurality of port portions other than the port portion to which the collection port portion is coupled such that a positive pressure is introduced thereinto, and
the liquid collection container includes a relief valve that releases, to an outside, an amount of air corresponding to an amount of the liquid flowing into the liquid collection container due to the pressurization of the liquid surface in the liquid accommodation container.

9. The liquid collecting device according to claim 2, wherein
a plurality of the liquid accommodation containers are provided to accommodate different types of liquids,
a plurality of the liquid collection containers are provided to respectively correspond to types of liquids to be collected from the liquid accommodation containers, and
the pressure generator is used for all of the plurality of liquid collection containers by being attached to and detached from the plurality of liquid collection containers or is used for all of the plurality of liquid accommodation containers by being attached to and detached from the plurality of liquid accommodation containers.

10. The liquid collecting device according to claim 9, wherein
the types of the liquids are colors of the liquids,
the plurality of liquid accommodation containers include first identification portions composed of first uneven portions having different uneven shapes respectively corresponding to colors of the liquids to be accommodated, each first identification portion being provided near the pouring port portion,
the plurality of liquid collection containers include second identification portions composed of second uneven portions having different uneven shapes respectively corresponding to the colors of the liquids to be collected, each second identification portion being provided near the collection port portion, and
the first identification portion and the second identification portion are formed in such shapes that the first uneven portion and the second uneven portion are engageable with each other only when the color of the liquid accommodated in the liquid accommodation container and the color of the liquid to be collected into the liquid collection container are the same as each other.

11. The liquid collecting device according to claim 1, wherein
the collection port portion also serves as a discharge port portion that is coupled to the pouring port portion when a liquid collected into the liquid collection container is to be supplied to the liquid accommodation container.
